(19) United States
(12) Patent Application Publication
(10) Pub. No.: US 2015/0057404 A1
(43) Pub. Date: Feb. 26, 2015

(54) Long-Term Zero-Fouling Polymer Surfaces

(71) Applicant: BIOREPELLER IVS, Copenhagen (DK)

(72) Inventors: Ryosuke Ogaki, Aarhus C (DK); Morten Foss, Skanderborg (DK)

(21) Appl. No.: 14/388,359

(22) PCT Filed: Mar. 26, 2013
(86) PCT No.: PCT/DK2013/050088

§ 371 Date: Sep. 26, 2014

(30) Foreign Application Priority Data
Mar. 29, 2012 (DK) PA 2012 70155

(51) Int. Cl. C09D 5/16; B05D 3/00

(52) U.S. Cl. CPC C09D 5/1637; B05D 3/005
USPC 524/498; 427/472

(57) ABSTRACT

The present invention relates to a method for producing non-fouling surfaces and products having such a surface. Especially, the present invention relates to a product comprising a bulk part and a surface region; wherein a first surface region coating is coated on at least a first part of said surface region; said first surface region coating comprising a polyionic co-polymer consisting of a polyionic backbone polymer and non-ionic hydrophilic side chain polymers; wherein the molecular spacing parameter, L/2R_{g}, of said first surface region coating is less than 0.26.

### TECHNICAL FIELD OF THE INVENTION

The present invention relates to a method for producing non-fouling surfaces and products having such a surface.

### BACKGROUND OF THE INVENTION

Material surfaces with non-fouling properties are essential for a wide range of bio-related applications in vitro and in vivo. Among a repertoire of candidate materials, poly(ethylene glycol) (PEG) derivatives have been widely utilized due to its high degree of hydration and steric-entropic barrier properties that provides excellent bio-repellence.

The preparation of non-fouling surfaces generally follows one of two approaches, “grafting-from” and “grafting-to” techniques. “Grafting-from” is preferentially used when high polymer densities and/or high layer thicknesses are aimed. This method, however, often requires inert substrates, highly controlled experimental conditions, specialized synthesis knowledge, and cannot always be applied to large products. In contrast, the “grafting-to” method is a simple and cost-effective dip-and-rinse procedure, compatible with complex 3D product shapes.

Substantial progress has been made in developing ‘grafting-to and -from’ strategies for immobilizing PEG derivatives on surfaces. The currently available bio-resisting surfaces are termed ‘non-fouling’ (typically 75-90% reduction) but still often fail to perform in application-relevant, pertinent conditions over an extended time period. Thus, the generation of long-term ‘zero-fouling’ surface continues to be an intensely focused research areas within the biomedical and biotechnological field.

Poly-l-lysine grafted PEG (PLL-g-PEG) is a widely used ‘grafting-to’ strategy that spontaneously adsorbs onto negatively charged surfaces via electrostatic interaction of positively charged amine groups from the PLL backbone, where the PEG side chains are forced to orient towards the aqueous phase forming a densely packed monolayer. The effects of molecular weight, grafting ratio of PLL to PEG components and the assembly conditions for resistance towards human serum, full blood plasma, mammalian and bacterial cells has been extensively studied over the last decade. The PEG chain length and surface graft density are important surface parameters for resisting protein adsorption; and techniques, such as ‘cloud point’ (CP) grafting are commonly employed to increase the grafting of PEG by reducing its hydrodynamic volume (Kingshott et al., Biomaterials 2002, 23, 2043-2056). CP grafting of PLL-g-PEG requires a reactive adlayer, such as a plasma polymer, due to the paradoxical effect of high ionic strength of the solution leading to Debye screening and hence to a weaker electrostatic attraction between PLL-g-PEG and the substrate. Although a significant increase in the grafting density of PLL-g-PEG was achieved, its resistance towards fouling has only been demonstrated on single protein over a short period (Blattler et al., Langmuir 2006, 22, 5760-5769.).

### SUMMARY OF THE INVENTION

Thus, an object of the present invention relates to improving the polymer grafting density of coated surfaces.

In particular, it is an object of the present invention to provide a process that solves, or at least improves, the above mentioned problems of the prior art with regard to resistance of a coated surface towards fouling.

Thus, one aspect of the invention relates to a method for modifying a surface characteristic of a product comprising:

a) Providing a product comprising a bulk part and a surface region, said surface region being positively or negatively charged;

b) Contacting at least a portion of the surface region with an aqueous coating composition having a temperature of at least 50 degrees Celsius to form a first surface region coating on at least a first part of said surface region;

wherein the aqueous coating composition comprises a polyionic co-polymer consisting of a polyionic backbone polymer and non-ionic hydrophilic side chain polymers;

wherein the liquid matter of the aqueous coating composition comprises at least 50% w/w of water;

provided that when the surface region is positively charged, said polyionic backbone polymer being negatively charged;

provided that when the surface region is negatively charged, said polyionic backbone polymer being positively charged;

wherein said polyionic co-polymer has a cloud point above the temperature of said coating composition when brought into contact with said at surface region under step b).

Another aspect of the present invention relates to a product comprising a bulk part and a surface region; wherein a first surface region coating is coated on at least a first part of said surface region; said first surface region coating comprising a polyionic co-polymer consisting of a polyionic backbone polymer and non-ionic hydrophilic side chain polymers; wherein the molecular spacing parameter, L/2R_{g}, of said first surface region coating is less than 0.26.

### BRIEF DESCRIPTION OF THE FIGURES

FIG. 1 shows (a) Hypothesized schematic representation of the proposed formation of ultra-dense PEG polyelectrolyte coating upon heating, as a result of increasing substrate surface zeta potential and increased electrostatic interaction between the amine groups from PLL and the negatively charged TiO₂ surface; (b) Chemical structure of PLL-g-PEG used in this study with PLL to PEG,

FIG. 2 shows relative surface elemental % determined from the XPS survey scan,

FIG. 3 shows high resolution C 1s and O 1s scans, highlighting the decrease in the substrate Ti 2p signal and increase in C—O signals with increase in temperature, indicating the gradual increase in the grafting of PLL-g-PEG with assembly temperature,

FIG. 4 shows normalized ToF-SIMS secondary ion intensities of C₂H₅O⁺ (m/z 45.03) indicative of PEG in different PLL-g-PEG preparation temperatures,

FIG. 5 shows a table of the overlayer thickness, z, the surface packing density, a and the degree of overlapping PEG chain, L/2R_{g} at various temperatures calculated from the XPS data,

FIG. 6 shows half-coated PLL-g-PEG surfaces prepared at 20° C. and 60° C. on TiO₂, after incubation in hDPSC for up to 36 days. The control surfaces at 20° C. and 60° C. incubated in HEPES buffer only are also included. Scale bar is 200 μm,

FIG. 7 shows half-coated PLL-g-PEG surfaces prepared at 20° C. and 60° C. on TiO₂, after incubation in hFb for up to 36 days. The control surfaces at 20° C. and 60° C. incubated in HEPES buffer only are also included. Scale bar is 200 μm,

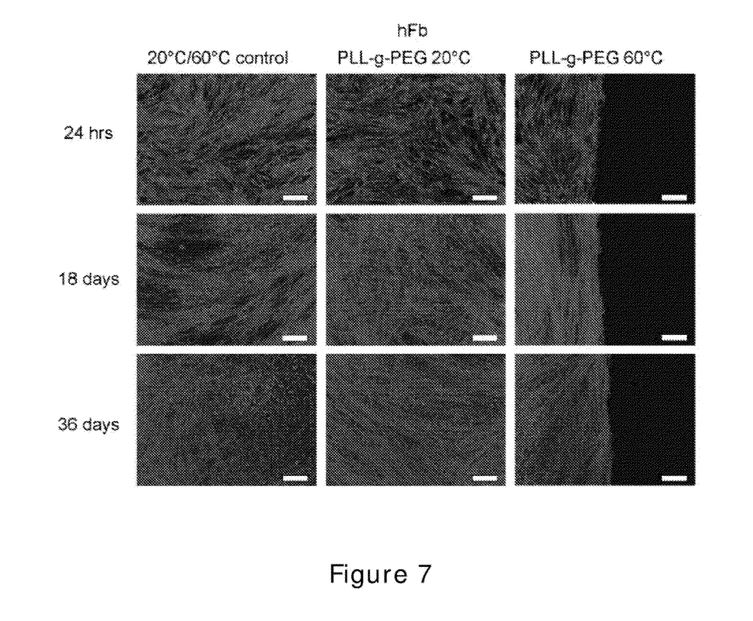

FIG. 8 shows XPS C 1s and N 1s high resolution scan before and after incubation for 36 days at 37° C. in 10% FBS/MEM and 24 hours in whole blood,

FIG. 9 shows ToF-SIMS normalised intensities of 14 amino acid positive secondary ions after incubation for 36 days in 10% FBS/MEM,

FIG. 10 shows ToF-SIMS normalised intensities of 14 amino acid positive secondary ions after incubation for 24 hours in whole blood,

FIG. 11 shows QCM 7^{th} overtone frequency (Δf₇/7^{th}) and dissipation (ΔD₇) traces of PLL-g-PEG adsorption at 20° C. and 40° C., with PLL-g-PEG adsorption at ˜400 seconds and washed with HEPES buffer after ˜1300 seconds,

FIG. 12 shows 2 μm×2 μm AFM topography images of PLL-g-PEG prepared in various temperatures. Scale bar is 0 to 3 nm,

FIG. 13 shows cell adhesion assay after 36 days highlighting the complete resistance of MC3T3 cells on TiO₂ (a) and hDPSC on TCPS (b), at the PLL-g-PEG coated/uncoated intersection. DIC images are shown on the right. Scale bar is 200 μm,

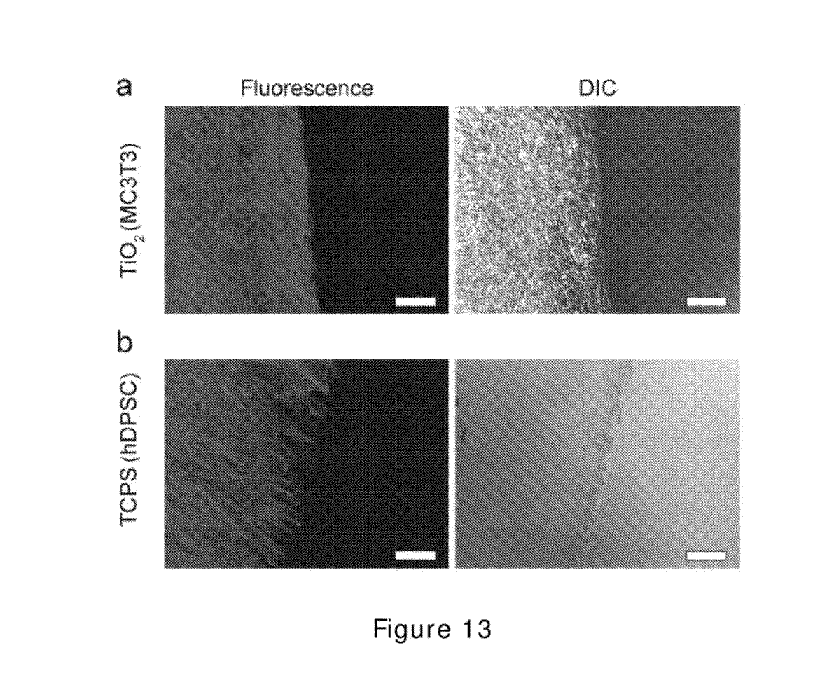

FIG. 14 shows the change in frequencies (Δfₙ/n^{th}, n=3, 5, 7) observed after short term adsorption of 10% FBS/MEM onto PLL-g-PEG surfaces prepared at different temperatures,

FIG. 15 shows elemental ratio of (a) N/O and (b) N/Ti determined from XPS survey spectra. No statistically significant differences between the N/O values before and after the incubations were found, indicating that protein adsorption have not occurred for the 60 and 80° C. samples. A reduction in the N/Ti values were observed after the incubation in blood and cell media for 60 and 80° C. samples, indicating that some of the PLL-g-PEG have desorbed from the surface,

FIG. 16 shows the C 1s high resolution XPS spectrum for grafted PLL-g-PEG onto TiO2 surfaces without (left column) and with (right column) the presence of PDA at different temperatures (20, 50 and 80° C.). The surfaces are incubated in extremely high ionic strength solution, 2.4M NaCl for 24 hours at 25° C. (+salt) and washed copiously in MilliQ water followed by exposure to undiluted FBS (+serum) for 24 hrs at 37° C. and subsequently washed in MilliQ water. (i) is the C—C/C—H at BE of 285.0 eV (charge corrected), (ii) is the C—N/C—O at BE ˜286.5 eV and (iii) is the N—C(═O)/O—C═O at BE of ˜288.2 eV, and

FIG. 17 shows the N 1s high resolution XPS spectrum for grafted PLL-g-PEG onto TiO2 surfaces without (left column) and with (right column) the presence of PDA at different temperatures (20, 50 and 80° C.). The surfaces are incubated in extremely high ionic strength solution, 2.4M NaCl for 24 hours at 25° C. (+salt) and washed copiously in MilliQ water followed by exposure to undiluted FBS (+serum) for 24 hrs at 37° C. and subsequently washed in MilliQ water.

FIG. 18 shows live/dead stain images of bare titanium after incubation in 3% Tryptic Soy Broth with Staphylococcus aureus without shaking at 37° C.

FIG. 19 shows live/dead stain images of PLL-g-PEG surface prepared at 20° C. after incubation in 3% Tryptic Soy Broth with Staphylococcus aureus without shaking at 37° C.

FIG. 20 shows live/dead stain images of PLL-g-PEG surface prepared at 80° C. after incubation in 3% Tryptic Soy Broth with Staphylococcus aureus without shaking at 37° C.

FIG. 21 shows study on the long term (7 days) bioresistance of bare Ti, PLL-g-PEG prepared at 20 and 80° C. and PLL-g-PEG biotin prepared at 80° C. in whole blood. Normalized secondary ion intensities of Serine from ToF-SIMS analysis are plotted against number of days in whole blood.

FIG. 22 shows study on the long term (7 days) bioresistance of bare Ti, PLL-g-PEG prepared at 20 and 80° C. and PLL-g-PEG biotin prepared at 80° C. in whole blood. Normalized secondary ion intensities of asparagine from ToF-SIMS analysis are plotted against number of days in whole blood.

FIG. 23 shows study on the long term (7 days) bioresistance of bare Ti, PLL-g-PEG prepared at 20 and 80° C. and PLL-g-PEG biotin prepared at 80° C. in whole blood. Normalized secondary ion intensities of threonine from ToF-SIMS analysis are plotted against number of days in whole blood.

FIG. 24 shows study on the long term (7 days) bioresistance of bare Ti, PLL-g-PEG prepared at 20 and 80° C. and PLL-g-PEG biotin prepared at 80° C. in whole blood. Normalized secondary ion intensities of isoleucine/leucine from ToF-SIMS analysis are plotted against number of days in whole blood.

FIG. 25 shows study on the long term (7 days) bioresistance of bare Ti, PLL-g-PEG prepared at 20 and 80° C. and PLL-g-PEG biotin prepared at 80° C. in whole blood. Normalized secondary ion intensities of histidine from ToF-SIMS analysis are plotted against number of days in whole blood.

FIG. 26 shows study on the long term (7 days) bioresistance of bare Ti, PLL-g-PEG prepared at 20 and 80° C. and PLL-g-PEG biotin prepared at 80° C. in whole blood. Normalized secondary ion intensities of phenylalanine from ToF-SIMS analysis are plotted against number of days in whole blood.

FIG. 27 shows a study with XPS revealing that the amount of PLL-g-PEG adsorption increases with incubation time when incubated at 80° C. This is highlighted by increasing ratio of ether (C—O, indicative of PEG) to Ti (Ti—O, indicative of substrate) with incubation time.

The present invention will now be described in more detail in the following.

### DETAILED DESCRIPTION OF THE INVENTION

One aspect of the invention relates to a method for modifying a surface characteristic of a product comprising:

a) Providing a product comprising a bulk part and a surface region, said surface region being positively or negatively charged;

b) Contacting at least a portion of the surface region with an aqueous coating composition having a temperature of at least 60 degrees Celsius to form a first surface region coating on at least a first part of said surface region;

wherein the aqueous coating composition comprises a polyionic co-polymer consisting of a polyionic backbone polymer and non-ionic hydrophilic side chain polymers;

wherein the liquid matter of the aqueous coating composition comprises at least 50% w/w of water;

provided that when the surface region is positively charged, said polyionic backbone polymer being negatively charged;

provided that when the surface region is negatively charged, said polyionic backbone polymer being positively charged;

wherein said polyionic co-polymer has a cloud point above the temperature of said coating composition when brought into contact with said at surface region under step b).

Another aspect of the invention relates to a method for modifying a surface characteristic of a product comprising:

a) Providing a product comprising a bulk part and a surface region, said surface region being positively or negatively charged;

b) Contacting at least a portion of the surface region with a coating composition having a temperature of at least 50 degrees Celsius to form a first surface region coating on at least a first part of said surface region;

wherein the aqueous coating composition comprises a polyionic co-polymer consisting of a polyionic backbone polymer and non-ionic hydrophilic side chain polymers;

wherein the liquid matter of the coating composition is polar; provided that when the surface region is positively charged, said polyionic backbone polymer being negatively charged;

provided that when the surface region is negatively charged, said polyionic backbone polymer being positively charged;

wherein said polyionic co-polymer has a cloud point above the temperature of said coating composition when brought into contact with said at surface region under step b).

In the present context, the term ‘polar liquid matter’ is to be understood as a liquid matter with a dielectric constant higher than 15 at 20 degrees Celsius.

Cloud Point: The cloud point is determined by making a 1% by weight solution of the polyionic co-polymer in water at 20 degrees Celsius, and then slowly heating the polyionic co-polymer solution with stirring until the solution turns cloudy or turbid. The cloud point determination of the polyionic co-polymer should be done under similar conditions, such as pH and ionic strength, as will exist in the coating composition. If the coating composition used to the make the coating of the present invention will contain water-soluble solvents, then these solvents should be included at the same concentration in the polyionic co-polymer solution during the determination of the cloud point.

In the present context ‘a method for modifying a surface characteristic of a product’ may particularly refer to a method of increasing the resistance of a surface towards fouling, in particular fouling selected from the group consisting of fouling in the form of non-specific bio-adsorption, fouling in the form of bacterial fouling such as bacterial biofilm, fouling in the form of thrombosis, and fouling in the form of protein adsorption.

In one embodiment, the polyionic co-polymer has a cloud point at least 5 degrees Celsius above the temperature of said coating composition when brought into contact with said at surface region under step b), such as within the range of 5-300 degrees Celsius above, e.g. 10 degrees Celsius above, such as within the range of 15-250 degrees Celsius above, e.g. 20 degrees Celsius above, such as within the range of 25-200 degrees Celsius above, e.g. 30 degrees Celsius above, such as within the range of 35-150 degrees Celsius above, e.g. 40 degrees Celsius above, such as within the range of 45-100 degrees Celsius above, e.g. 50 degrees Celsius above the temperature of said coating composition when brought into contact with said at surface region under step b).

A hydrophilic molecule or portion of a molecule is one that has a strong affinity for water thereby tending to dissolve in, mix with, or be wetted by water. In the present context, the non-ionic hydrophilic side chain polymers are examples of a portion of a hydrophilic molecule.

The aqueous coating composition include brush copolymers based on a poly-cationic or poly-anionic (jointly referred to herein as ‘polyionic’) backbone with side chains that control interaction with the environment, such as poly(ethylene glycol) or poly(ethylene oxide)-based side chains that decrease cellular adhesion (referred to herein as ‘non-interactive’ side chains or polymers).

Examples of polyionic backbone polymers are poly(amino acids) such as poly(lysine) and poly(arginine) with positive charges at physiological pH and poly(glutamic acid) and poly(aspartic acid) with negative charges at physiological pH.

An example of a non-ionic hydrophilic side chain polymer is the poly(ethylene glycol) (PEG) chain, which is highly water soluble and highly flexible. PEG chains have an extremely high motility in water and are essentially non-ionic in structure. They are well known for their weak interaction with both molecules and ions and, if attached to the surface in suitable form (molecular weight, density, orientation); they decrease adhesiveness or adsorption to the surface, such as protein resistance in contact with blood or serum. The choice of positively charged (cationic) or negatively charged (anionic) backbones of such PEO-grafted backbones is related to the fact that surfaces often possess a positive or negative charge when exposed to an aqueous environment.

In particular, metal oxides or metal oxide coatings exposed to an aqueous solution, spontaneously acquire a negative charge at pH above the isoelectric point (IEP) and positive charges at pH below the isolectric point of the particular oxide chosen. At pH of 7 (neutral solution) for example, niobium oxide, tantalum oxide or titanium oxide will be negatively charged, while aluminium oxide at pH 7 is positively charged.

In other cases, such as a noble metal surface, the surface may not be (sufficiently) charged to allow for complete polymer adsorption through electrostatic interaction. In such cases the surface may be treated to introduce positive or negative charges. For example, carboxylate groups may be introduced through self-assembly of carboxy-terminated long-chain alkanethiols on gold or silver to induce a positive charge at a pH above 4. The surfaces could also be pre-coated with e.g. polydopamine, which is virtually applicable to any surface.

### Compositions of Polyionic Co-Polymers

Block copolymers are defined as co-polymers in which a polymeric block is linked to one or more other polymeric blocks. This is distinguished from random co-polymers, in which two or more monomeric units are linked in random order to form a copolymer. Brush co-polymers (as in a bottlebrush) are co-polymers, which have a backbone of one composition and bristles of another. These co-polymers are also known as comb co-polymers.

The terms brush and comb are used interchangeably throughout this application.

The polyionic co-polymers of the present invention can be brush copolymers (as in a bottlebrush, with a backbone of one composition and bristles of another) with a charged polymeric backbone, such as a poly(amino acid). The first example refers to poly-L-lysine (PLL) and bristles of polyethylene glycol (PEG). The molecular weight of the PLL is between 1,000 and 1,000,000, preferably greater than 100,000, more preferably, between 300,000 and 800,000. The molecular weight of the PEG is between 500 and 2,000,000, more preferably between 1,000 and 100,000. Various surfaces binding polyionic polymers can be substituted for PLL, and various non-interactive polymers can be substituted for PEG.

For clarity, the following system of abbreviations will be used when referring to the various polymers discussed in this paper: PLL(mol. wt. PLL)-g[graft ratio]-PEG(mol. wt. PEG) signifies that the graft copolymer has a PLL backbone of molecular weight of (mol. wt. PLL) in kD. a graft ratio of lysine-mer/PEG side chain and PEG side chains of molecular weight (mol. wt. PEG) in kD (kilo Dalton).

### Non-Ionic Hydrophilic Side Chain Polymers

Non-ionic hydrophilic side chain polymers are non-interactive. In the present context, the term ‘non-interactive’ means that the non-interactive polymer in the surface-adsorbed polyionic co-polymer reduces the amount of (non-specific) adsorption of molecules such as inorganic ions, peptides, proteins, saccharides and other constituents contained in typical fluids of biological or non-biological origin. Alternative terms to ‘non-interactive’ are non-adhesive, adsorption-resistive or adsorption-repulsive. PEG is a preferred material as the non-interactive polymer (non-ionic hydrophilic side chain polymer).

The choice of the grafting ratio (number of monomers in the polymeric polyionic backbone polymer divided by the number of PEG chains) is important as it determines, when adsorbed onto the product surface, the density of PEG chains on the surface and thus the degree of the desired non-adhesiveness.

For PEG with a molecular weight (MW) of 5000 Da, the optimal graft ratio is between 1 PEG chain for every 3 to 10, preferably 4 to 7, lysine subunits for analytical or sensing applications, and may be adjusted based on desired properties. However, the optimum grafting ratio also depends on the MW of the PEG as well as on the specific applications. For example, if the MW of the PEG chains to be grafted onto the PLL backbone is 2000 Da, the ratio of PLL units to PEG units could be between 2.1 and 22.6, preferably below 5, such as below 4, e.g. within the range of 2 and 4.

In one embodiment, the grafting ratio between the polyionic backbone polymer and the non-ionic hydrophilic side chain polymer is within the range of 2-25, such as 2-20, e.g. within the range of 2-15, such as 3-10, e.g. within the range of 3-7.

Suitable non-ionic hydrophilic side chain polymers include mixed polyalkylene oxides having a solubility of at least one gram/litre in aqueous solutions such as some poloxamer non-ionic surfactants, neutral water-soluble polysaccharides, polyvinyl alcohol, poly-N-vinyl pyrrolidone, non-cationic poly(meth)acrylates, many neutral polysaccharides, including dextran, ficoll, and derivatized celluloses, polyvinyl alcohol, non-cationic polyacrylates, such as poly(meth)acrylic acid, and esters amide and hydroxyalkyl amides thereof, and combinations thereof.

In one embodiment of the present invention, the non-ionic hydrophilic side chain polymers are selected from the group consisting of poly(alkylene glycols), poly(alkylene oxides), neutral water-soluble polysaccharides, polyvinyl alcohol, poly-N-vinyl pyrrolidone, non-cationic poly(meth)acrylates and combinations thereof.

### Polyionic Backbone Polymers

The aqueous coating composition include brush copolymers based on a poly-cationic or poly-anionic (jointly referred to herein as ‘polyionic’) backbone with side chains that control interaction with the environment, such as poly(ethylene glycol) or poly(ethylene oxide)-based side chains that decrease cellular adhesion (referred to herein as ‘non-interactive’ side chains or polymers).

The polyionic backbone polymer comprises polyionic blocks, poly-cationic blocks or poly-anionic blocks.

Suitable polycationic blocks include natural and synthetic polyamino acids having net positive charge at or close to neutral pH, positively charged polysaccharides, and positively charged synthetic polymers. Representative polycationic blocks include monomeric units selected from the group consisting of lysine, histidine, arginine and ornithine. Representative positively charged polysaccharides include chitosan, partially deacetylated chitin and amine-containing derivatives of neutral polysaccharides. Representative positively charged synthetic polymers include polyethyleneimine, polyamino(meth)acrylate, polyaminostyrene, polyaminoethylene, poly(aminoethyl)ethylene, polyaminoethylstyrene, and N-alkyl derivatives thereof. Representative polycationic materials include natural and unnatural polyamino acids having net positive charge at neutral pH, positively charged polysaccharides, and positively charged synthetic polymers. Examples of suitable polycationic materials include polyamines having amine groups on either the polymer backbone or the polymer sidechains, such as poly-L-lysine and other positively charged polyamino acids of natural or synthetic amino acids or mixtures of amino acids, including poly(D-lysine), poly(ornithine), poly(arginine), and poly(histidine), and nonpeptide polyamines such as poly(aminostyrene), poly(aminoacrylate), poly(N-methyl aminoacrylate), poly(N-ethylaminoacrylate), poly(N,N-dimethyl aminoacrylate), poly(N,N-diethylaminoacrylate), poly(aminomethacrylate), poly(N-methyl amino-methacrylate), poly(N-ethyl aminomethacrylate), poly(N,N-dimethylaminomethacrylate), poly(N,N-diethyl aminomethacrylate), poly(ethyleneimine), polymers of quaternary amines, such as poly(N,N,N-trimethylaminoacrylate chloride), poly(methylacrylamidopropyl-trimethylammonium chloride), and natural or synthetic polysaccharides such as chitosan. Polylysine is a preferred material. In general, the polymers must include at least five charges, and the molecular weight of the polyionic material must be sufficient to yield the desired degree of binding to the surface of the product (such as an analytical or sensing device), having a molecular weight of at least 1000 g/mole.

For example, PEG reacted with polyethylene imine with a molecular weight greater than 10,000 will have approximately the same physical properties as the PEG/PLL copolymers described herein. Polyhydroxyethyl methacrylate can be reacted with a suitable stoichiometric ratio of a reagent such as tresyl or tosyl chloride (an activating agent), which converts some of the hydroxy groups to leaving groups. These leaving groups can be reacted with polycationic polymers, for example, polyaminoethyl methacrylate with a molecular weight greater than 10,000 to yield a high-molecular-weight polymer. A suitable stoichiometric ratio is one mole activating agent per mole of polyhydroxyethyl methacrylate, and one mole activated polyhydroxyethyl methacrylate per every 3 to 9, preferably 5 to 7 moles of reactive groups on polyaminoethyl methacrylate. Suitable cationic polymers are those that, when combined with a suitable non-interactive polymer, have roughly the same physical properties as the PEG/PLL copolymers described herein. Suitable polyanionic blocks include natural and synthetic polyamino acids having net negative charge at neutral pH. A representative polyanionic block is poly(glutamic acid) which contains carboxylic acid side chains with a negative charge at pH 7. Glycolic acid is just one example. It may be replaced by other natural or synthetic monomers that can be polymerized and contain a side functional group with negative charge at or near neutral pH, for example, any polymer having carboxylic acid groups attached as pendant groups. Suitable materials include alginate, carrageenan, furcellaran, pectin, xanthan, hyaluronic acid, heparin, heparan sulfate, chondroitin sulfate, dermatan sulfate, dextran sulfate, poly(meth)acrylic acid, oxidized cellulose, carboxymethyl cellulose and crosmarmelose, synthetic polymers and copolymers containing pendant carboxyl groups, such as those containing maleic acid or fumaric acid in the backbone. Polyaminoacids of predominantly negative charge are particularly suitable. Examples of these materials include polyaspartic acid, polyglutamic acid, and copolymers thereof with other natural and unnatural amino acids. Polyphenolic materials such as tannins and lignins can also be used. Preferred materials include alginate, pectin, carboxymethyl cellulose, heparin and hyaluronic acid. In general, the molecular weight of the polyanionic material must be sufficiently high to yield strong adhesion to the positively charged surface. The lengths of the polycationic and polyanionic materials which would result in good blockage of adhesive interactions may be determined by routine experimentation. It should be understood that “good” is a word that must be defined by the requirements of the particular situation at hand, e.g., how long binding is required and how complete a non-interactivness is required by the particular application. The amine groups in copolymers are the primary amines of lysine residues, but other groups can be used. For example, the polymer can be prepared using arginine or histidine, resulting in guanidino or imidazoyl cationic groups, respectively.

For all embodiments, the molecular weight and number of PEG blocks per lysine block is determined such that the resulting copolymer has the properties of both the PLL and the PEG. If the proportion of PEG is too high, the adhesion of the polymer to the surface is reduced. If the proportion of PLL is too high, the ability of the PEG to reduce the non-specific adsorption of ions and molecules is insufficient. The polymers must have sufficient PEG character to minimize molecular interaction with the surface. Polymers with too few PEGs per PLL are less suitable for minimizing these interactions. The polymers must also have sufficient PLL character to adequately bind to a surface. Polymers with insufficient PLL character fail to bind adequately. The polycationic polymer can be any polycation that provides a sufficient amount and density of cationic charges to be effective at adhering to the product surface.

In one embodiment of the present invention, the polyionic backbone polymer has a cationic charge at a pH greater than 4, such as within the range of 4-10, e.g. 5, such as within the range of 6-9, e.g. 7.4.

In another embodiment, the polyionic backbone polymer comprises a cationic backbone selected from the group consisting of polymers comprising amino acids containing side group imparting a positive charge to the backbone at pH greater than 4, polysaccharides, polyamines, polymers of quaternary amines, and charged synthetic polymers.

In yet another embodiment, the cationic backbone comprises one or more units selected from the group consisting of lysine, histidine, arginine and ornithine in a D-, L- or DL configuration, chitosan, partially deacetylated chitin, amine-containing derivatives of neutral polysaccharides; poly(aminostyrene), poly(aminoacrylate), poly(N-methyl aminoacrylate), poly(N-ethylaminoacrylate), poly(N,N-dimethyl aminoacrylate), poly(N,N-diethylaminoacrylate), poly(aminomethacrylate), poly(N-methyl amino-methacrylate), poly(N-ethyl aminomethacrylate), poly(N,N-dimethylaminomethacrylate), poly(N,N-diethyl aminomethacrylate), poly(ethyleneimine), poly(N,N,N-trimethylaminoacrylate chloride), poly(methyacrylamidopropyltrimethyl ammonium chloride), polyethyleneimine, polyamino(meth)acrylate, polyaminostyrene, polyaminoethylene, poly(aminoethyl)ethylene, polyaminoethylstyrene, and N-alkyl derivatives thereof.

In one embodiment, the polyionic backbone polymer has an anionic charge at a pH greater than 4, such as within the range of 4-10, e.g. 5, such as within the range of 6-9, e.g. 7.4.

In another embodiment, the polyionic backbone polymer comprises a polymer selected from the group consisting of polymers comprising amino acids containing pendant charged groups imparting a negative charge to the backbone at pH greater than 4, polysaccharides, and charged synthetic polymers with pendant negatively charged groups.

In yet another embodiment, the anionic backbone comprises one or more units selected from the group consisting of polyaspartic acid, polyglutamic acid, alginate, carrageenan, furcellaran, pectin, xanthan, hyaluronic acid, heparin, heparan sulfate, chondroitin sulfate, dermatan sulfate, dextran sulfate, poly(meth)acrylic acid, oxidized cellulose, carboxymethyl cellulose and crosmarmelose, maleic acid polymers, and fumaric acid polymers.

In one embodiment, the polyionic co-polymer is selected from the group consisting of PLL-g-PEG, PLL-g-dex, PLL-g-PMOXA

In another embodiment, the polyionic co-polymer is selected from the group consisting of poly(L-lysine-g-ethylene glycol) (PLL-g-PEG), poly(L-lysine-g-hyaluronic acid) (PLL-g-HA), poly(L-lysine-g-phosphoryl choline) (PLL-g-PC), poly(L-lysine-g-PVP), poly(ethylimine-g-ethylene glycol) (PEI-g-PEG), poly(ethylimine-g-hyaluronic acid) (PEI-g-HA), poly(ethylimine-g-phosphoryl choline) (PEI-g-PC), and poly(ethylimine-g-vinylpyrrolidone) (PEI-g-PVP).

In another embodiment, the polyionic co-polymer is a PLL-g-PEG. In yet another embodiment the polyionic co-polymer is PLL-g-PEG functionalized with a marker molecule, such as PLL-g-PEG-biotin, PLL-g-PEG-FITC, PLL-g-PEG-TRIC, PLL-g-PEG-atto633, PLL-g-PEG-NTA, or PLL-g-PEG-RGD.

In a preferred embodiment the polyionic co-polymer is selected from the group consisting of PLL(20 kDa)-g[3.5]-PEG(2 kDa), PLL(20 kDa)-g[3.5]-PEG(5 kDa), PLL(20 kDa)-g[3.5]-PEG(2 kDa)/PEG(3.4 kDa)-biotin(20%), PLL(20 kDa)-g[3.5]-PEG(2 kDa)/PEG(3.4 kDa)-biotin(50%), PLL(20 kDa)-g[3.5]-PEG(2 kDa)-FITC (fluorescent green label), PLL(20 kDa)-g[3.5]-PEG(2 kDa)-TRIC (fluoescent red label), PLL(20 kDa)-g[3,5]-PEG(2 kDa)-Atto633 (fluorescent near IR label), PLL(20 kDa)-g[3.5]-PEG(3.4 kDa)-NTA, PLL(20 kDa)-g[3.5]-PEG(2 kDa)/PEG(3.4 kDa)-RGD,

In yet another embodiment, the PLL-g-PEG is PLL(20 kDa)-g (3.3)-PEG(5 kDa).

### Surfaces

The type of surfaces suitable for the envisioned use depends on both the type of application, as well as on the suitability for binding the polyionic copolymer.

All types of substrates or substrate surfaces that are used in the area of analytical or sensing tasks which can be combined with any technique for the detection of the target molecules or analytes. Suitable substrates or surfaces which include metals, metal oxides and/or polymeric materials are also discussed below in conjunction with the section on detection of analyte binding. Other substrates or surfaces include tissue and cell culture substrates, and means for immunoassay, which are typically formed of a polymer such as polystyrene or polycarbonate. Substrates may include organic or inorganic nanoparticles, such as silica nanoparticles, titania-, polystyrene-, and poly methyl methacrylate nanoparticles Other supports or substrates include medical devices or prosthetics which are formed of metals (such as stainless steel), nylon, degradable and non-degradable biocompatible polymers such as poly(lactic acid-co-glycolide). Examples include bone implants and prosthetics, vascular grafts, pins, screws, and rivits. The most common substrate material for a stent is a metal. In many such implants, used in dentistry and in orthopaedic surgery, metal implants are used. In other cases, polymeric implants may be more useful. It is possible to adsorb the multifunctional polymer to either polymeric or inorganic substrates, depending only upon the surface charge of the substrate. Substrate and surface functionalization for use in other analytical assay platforms is also an important application of the technology. One of the largest areas in bioanalytical assays is the use of enzyme linked immunosorbent assays (ELISA) or linked immunosorbent assays (LISA). In these applications, a binding or recognition element is bound typically to a multiwell plate and then blocked with a protein based molecule to occupy surface area not containing the recognition element. The derivatized surface is then exposed to a solution containing analyte. The surface is then exposed to a second recognition element that is tagged with a molecule that can be assayed via any of the conventional spectroscopic or other methods. The above description is for a typical “sandwich” type assay, and this basic format can be modified in a variety of standard ways. For example, an antigen can be directly coupled to a surface and used to assay the level of antibody produced from immunological response to the antigen and present in biological fluids or tissues. This is a common technique used for determination of human disease or illness or even for determination of biocompatability of a drug or implant in which the degree of antibody production is measured as a function of drug level or dose. One of the key issues with the assays is the blocking step that prevents non-specific binding. This step is time consuming and variable, and can generate false positive. Conventional methods for blocking of sites not occupied by the antigen or antibody include blocking with proteins, for example bovine serum albumin (BSA).

Functionalization of surfaces for the analysis and control of cellular interactions is an important use, having application in culture-based assays, in therapeutics based on cell and tissue culture and bioreactors, and based on implants. Functionalized surfaces can be used in bioanalytical systems involving cells. in which the cellular response is the measured feature. In the field of cell biology, the response of a cell to a substrate is an important issue, and analysis of this response is an important bioanalytical task. For example, the response of a cell to extracellular matrix components is an important issue in cell adhesion and migration and is important in issues such as cancer metastasis and wound healing. As such, bioanalytical systems, including as a key component of them bioanalytical surfaces and substrates, are useful in measurement of such responses.

Useful substrates are polymeric or inorganic. Modified polystyrene is a common cell culture substrate, modified so as to render the polystyrene anionic. Such a substrate alone has limited usefulness in bioanalysis of cellular behaviour. It supports cell adhesion via proteins that spontaneously adsorb or are adsorbed from purified solutions. These proteins are subject to remodelling by cellular activities. As such, technology that would provide a well-defined culture substrate would indeed be useful. In such usefulness, qualities such as the ability to resist nonspecific adsorption, to present biospecific adhesion ligands, and to remain stably adsorbed during extensive periods of culture.

In one embodiment, the surface region comprises a material selected from the group consisting of metals, metal oxides, inorganic materials, organic materials, and polymers.

### Temperature of Coating Composition

In general, the solubility of polymers increases with increasing temperature. However, for non-ionic polymers including PEG, the solubility decreases with increasing solvent temperature. Therefore, it is generally accepted that electrostatic adsorption of co-polymers containing non-ionic polymers is optimum at around room temperature.

Surprisingly, the inventors of the present invention have found experimental evidence that an increase in temperature from the normal utilized room temperature to at least 50 degrees Celsius, but below the boiling point of the coating composition, during PEG polyelectrolyte self-assembly results in formation of an ultra-dense PEG coating, presumably as a result of increasing substrate surface charge density.

The inventors hypothesize that by increasing the temperature of a negatively charged substrate, the substrate zeta potential will increase, resulting in increased electrostatic interaction between PLL-g-PEG and the substrate by possibly overcoming the steric repulsion experienced between the PLL-g-PEG molecules under the standard assembly condition (room temperature), forming a densely packed PEG layer on the surface. This principle is expected to apply equally to positively charged substrates and negatively charged polyionic co-polymers.

In one embodiment, the aqueous coating composition has a temperature of at least 50 degrees Celsius, such as within the range of 55-100 degrees Celsius, e.g. 60 degrees Celsius, such as within the range of 65-95 degrees Celsius, e.g. 70 degrees Celsius, such as within the range of 75-85 degrees Celsius, e.g. 80 degrees Celsius.

In another embodiment, the aqueous coating composition has a temperature of at least 60 degrees Celsius, such as within the range of 65-99 degrees Celsius, e.g. 67 degrees Celsius, such as within the range of 70-90 degrees Celsius, e.g. 73 degrees Celsius, such as within the range of 80-85 degrees Celsius, e.g. 83 degrees Celsius.

The inventors have surprisingly found that when higher temperatures are used during coating, the adsorption continues for much longer than when using room temperature (20° C.) conditions. Thus, when using room temperature conditions the adsorption typically reaches a maximum level after about 30 minutes (see e.g. Kenausis et al., J. Phys. Chem. B 2000, 104, 3298-3309), whereas for the raised temperature experiments herein the adsorption continues to rise in a near-linear fashion even after 1000 minutes.

Thus a method according to the present invention is preferred wherein the polyionic co-polymer continues to form a first surface region coating after contacting said surface region with the coating composition for at least 30 min, such as at least 60 min, 90 min, 120 min, 240 min, 350 min, 500 min, such as at least 800 min.

### Effect of Buffering

Electrostatic interactions between the surface to be coated and the polyionic co-polymer in the coating composition depend on the surface charge and the polyionic co-polymer, both of which are dependent on pH and electrolyte composition. One way of controlling the electrostatic interactions during the coating process is therefore to use of a buffer, having an effect on both pH and ionic strength of the coating composition.

In one embodiment of the present invention, the coating composition comprises a buffer.

In another embodiment, the buffer has an ionic strength within the range of 1-300 mM, such as within the range of 10-250 mM, e.g. within the range of 15-225 mM, such as within the range of 20-200 mM, e.g. within the range of 25-175 mM, such as within the range of 30-150 mM, e.g. within the range of 35-125 mM, such as within the range of 40-115 mM, e.g. within the range of 45-110 mM, such as within the range of 50-105 mM, e.g. within the range of 55-100 mM, such as within the range of 60-95 mM, e.g. within the range of 65-90 mM, such as within the range of 70-85 mM, e.g. within the range of 75-80 mM.

In yet another embodiment, the buffer has an ionic strength within the range of 1-100 mM.

In one embodiment, the buffer is selected from the group consisting of HEPES, TRIS, TAPS, Bicine, Tricine, TAPSO, TES, MOPS, PIPES, Cacodylate, SSC, MES, ADA, ACES, BES, Cholamine chloride, Acetamidoglycine, and glycinamide.

It is known that salts may be added to the coating compositions for adsorption of polyionic polymers to substrates in order to enhance adsorption under certain conditions. Salts include inorganic salt such as e.g. NaCl, KCl, K₂SO₄. However, salts do not need to be added in the method according to the present invention to achieve high adsorption of polymer, and thus in a preferred embodiment a method is provided wherein no salts are to the coating composition, particularly inorganic salts.

In one embodiment of the present invention, the liquid matter of the aqueous coating composition comprises at least 1% w/w of water, such as within the range of 5-100% w/w, e.g. at least 10% w/w, such as within the range of 15-95% w/w, e.g. at least 20% w/w, such as within the range of 25-90% w/w, e.g. at least 30% w/w, such as within the range of 35-85% w/w, e.g. at least 40% w/w, such as within the range of 45-80% w/w, e.g. at least 50% w/w, such as within the range of 55-75% w/w, e.g. at least 60% w/w, such as within the range of 65-70%.

In another embodiment, the liquid matter of the coating composition is selected from the group of water, alcohols, carboxylic acids, amides, esters and ketones and mixtures thereof.

In still another embodiment, the liquid matter of the coating composition is selected from the group of water, methanol, ethanol, acetone, acetic acid, methanamide and mixtures thereof. Even though many carboxylic acids, amides, esters and ketones are solid at room temperature, they are still considered part of the liquid matter when mixed with water.

One aspect relates to a product obtainable by the process of the present invention.

Another aspect of the present invention relates to a product comprising a bulk part and a surface region; wherein a first surface region coating is coated on at least a first part of said surface region; said first surface region coating comprising a polyionic co-polymer consisting of a polyionic backbone polymer and non-ionic hydrophilic side chain polymers; wherein the molecular spacing parameter, L/2R_{g}, of said first surface region coating is less than 0.26.

In one embodiment, the molecular spacing parameter, L/2Rg, of said first surface region coating is within the range of 0.004-0.260, such as within the range of 0.005-0.255, e.g. within the range of 0.010-0.250, such as within the range of 0.015-0.245, e.g. within the range of 0.020-0.240, such as within the range of 0.025-0.235, e.g. within the range of 0.030-0.230, such as within the range of 0.035-0.225, e.g. within the range of 0.040-0.220, such as within the range of 0.045-0.215, e.g. within the range of 0.050-0.210, such as within the range of 0.055-0.205, e.g. within the range of 0.060-0.200, such as within the range of 0.065-0.195, e.g. within the range of 0.070-0.190, such as within the range of 0.075-0.185, e.g. within the range of 0.080-0.180, such as within the range of 0.085-0.175, e.g. within the range of 0.090-0.170, such as within the range of 0.095-0.165, e.g. within the range of 0.100-0.160, such as within the range of 0.105-0.155, e.g. within the range of 0.110-0.150, such as within the range of 0.115-0.145, e.g. within the range of 0.120-0.140, such as within the range of 0.135-0.140.

It should be noted that embodiments and features described in the context of one of the aspects of the present invention also apply to the other aspects of the invention. Particularly the embodiments relating to the chemicals, compounds and solvents used in the method aspect also apply to the product aspect. As an example, embodiments relating to the polyionic co-polymer apply to both the process and the product.

All patent and non-patent references cited in the present application, are hereby incorporated by reference in their entirety.

The invention will now be described in further details in the following non-limiting examples.

### EXAMPLES

### Example 1

### Increasing Temperature During Electrostatically Driven Assembly of Poly(Ethylene Glycol) Co-Polymer Generates Long-Term ‘Zero-Fouling’ Surface

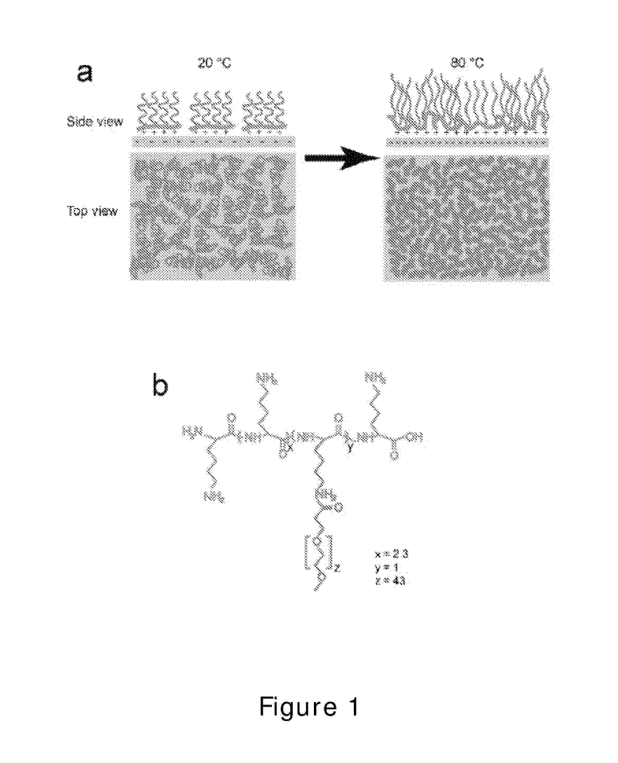

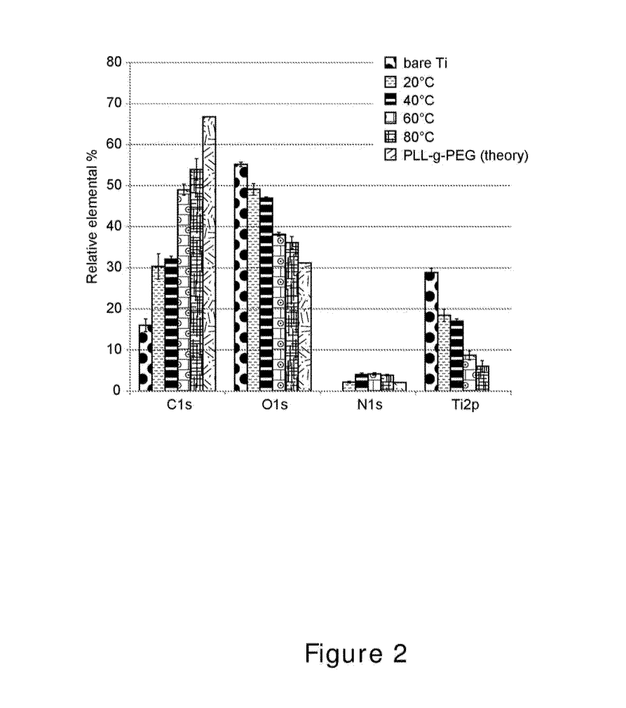

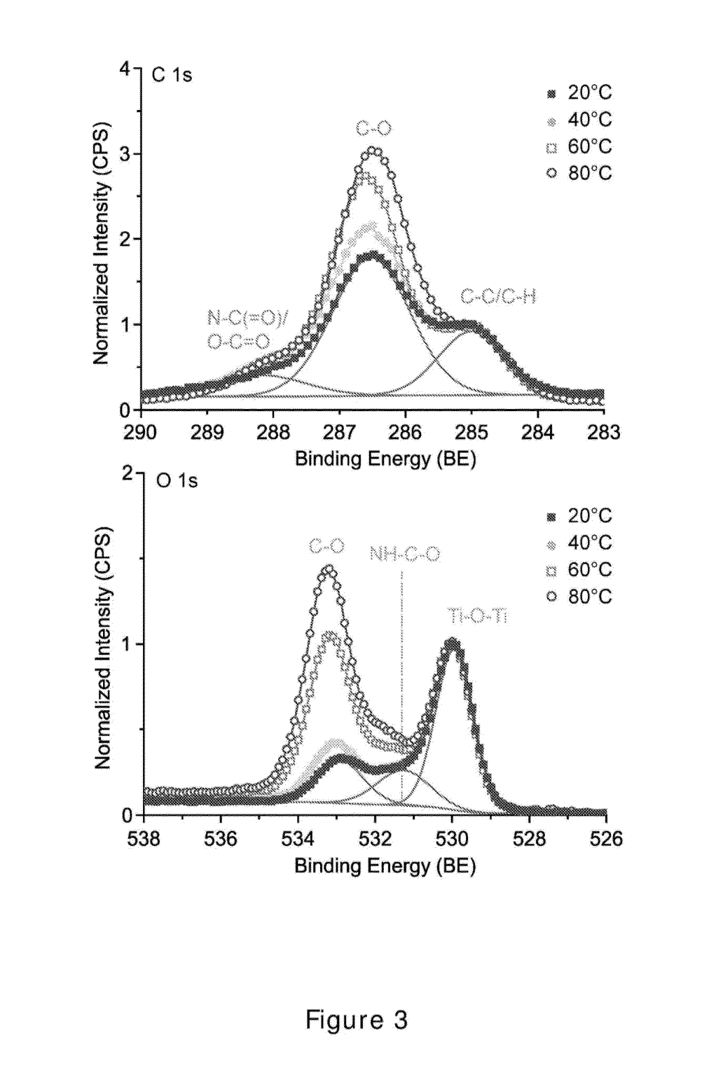

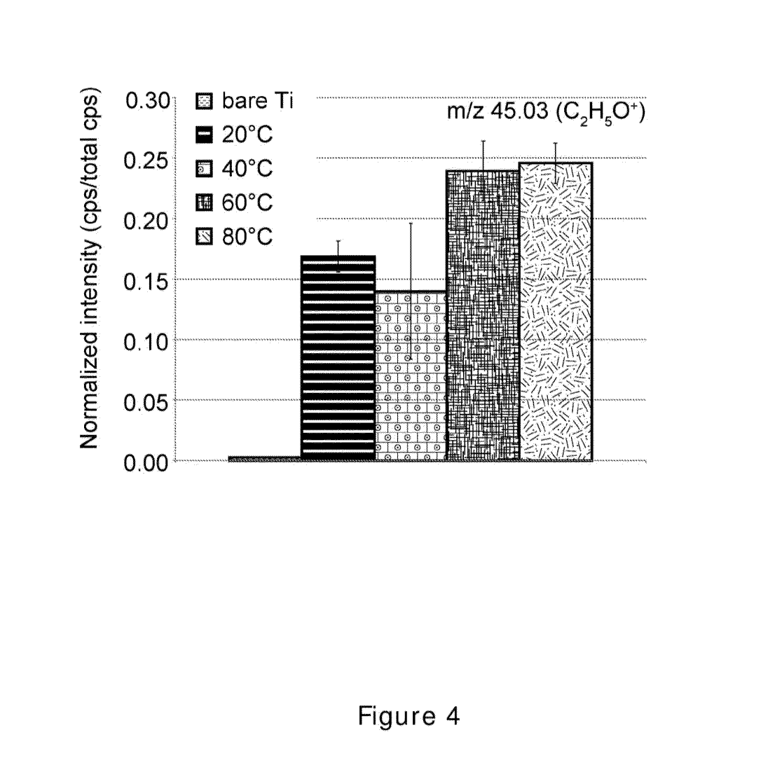

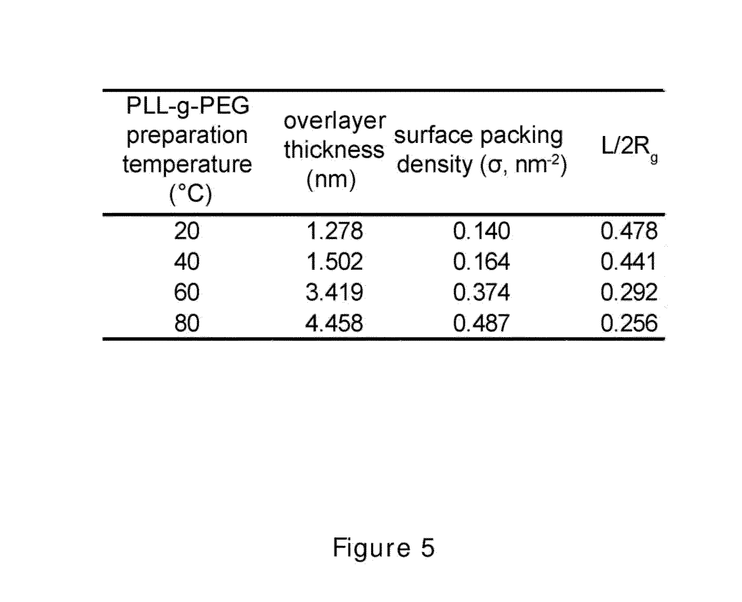

In the following, the inventors of the present invention present experimental evidence where increasing temperature alone during PEG polyelectrolyte self-assembly results in formation of an ultra-dense PEG coating, presumably as a result of increasing substrate surface charge density. The inventors rationally hypothesize that by increasing the temperature of a negatively charged substrate, the substrate zeta potential will increase, resulting in increased electrostatic interaction between PLL-g-PEG and the substrate by possibly overcoming the steric repulsion experienced between the PLL-g-PEG molecules under the standard assembly condition, forming a densely packed PEG layer on the surface (FIG. 1a). Despite the existence of limited data, Earth Science and Microfluidics research have indicated that the magnitude of the substrate surface zeta potential increases linearly with temperature (Revil et al, J. Geophys. Res. 1999, 104, 20021-20031). The inventors first assembled PLL (20 kDa)-g (3.3)-PEG (5 kDa) (FIG. 1b) onto TiO₂ surfaces at different temperatures (20, 40, 60 and 80° C.) in low ionic strength conditions (10 mM HEPES buffer). X-ray photoelectron spectroscopy (XPS) confirmed the successful immobilization of PLL-g-PEG onto TiO₂ surfaces at all temperatures from the presence of nitrogen (N) from the survey scans (FIG. 2) and the ether (C—O, C 1s BE of ˜286.5 eV, O 1s BE of ˜533.0 eV) and amide/carboxyl (N—C(═O), O—C═O, C 1s BE of ˜288.5 eV, O 1s BE of ˜531.5 eV) components in the high resolution C 1s and O 1s spectra (FIG. 3). By normalizing the high resolution spectra to the C—C/C—H component (BE of 285.0 eV) in C 1s and titanium oxide (Ti—O—Ti) component (BE of 530 eV) in O 1s, the C—O component indicative of PEG has increased ˜2 times in C 1s and ˜6 times in O 1s from 20° C. to 80° C. respectively. Similar results were observed from the time of flight secondary ion mass spectrometry (ToF-SIMS) positive ion spectra with the highest normalized intensity of the secondary ion signal indicative of PEG (C₃H₅O₂⁺, m/z 45.03) observed at 80° C. (FIG. 4). Despite the semi-quantitative nature of ToF-SIMS, the intensity of PEG secondary ion signal should increase with an increased amount of PEG on the surface due to the higher probability of the secondary ion formation and detection. The change in the Ti 2p signal from XPS data was monitored to calculate the ‘overlayer’ thickness of adsorbed PLL-g-PEG, the PEG chain surface packing density, σ, and L/2R_{g}, where L relates to the distance between each PEG side chain and R_{g} is the radius of gyration (FIG. 5). To determine the adsorbed PLL-g-PEG overlayer thickness, the inelastic mean free path (IMFP) was first estimated from the chemical structure using quantitative structure-property relationships (QSPR) derived by Cumpson (Cumpson et al, Surface and Interface Analysis, 2001, 31, 23-34). Briefly, molecular index at the zero-order, ⁰χ^{(v)}, from the repeat structural unit of the studied PLL-g-PEG (i.e. 3.3 PLL unit to 1 PEG side chain unit) omitting hydrogen is determined using the valence connectivity index values of common organic elements, δ^{(v)} (Cumpson et al, Surface and Interface Analysis, 2001, 31, 23-34). The ⁰χ^{(v)} of PLL-g-PEG is the sum of the reciprocal square roots of the valence connectivity index, δ^{(v)}, which is defined as:

$${δ}^{( v )} = \frac{{Z}^{( v )} - h}{Z - {Z}^{( v )} - 1} \qquad ( 1 )$$

Where Z^{(v)} is the number of valence electrons in an atom, h is the number of hydrogen atoms bonded and Z is its atomic number. The values of δ^{(v)} takes into the account of both valence and core electrons. The calculated ⁰χ^{(v)} of the PLL-g-PEG repeat unit was found to be 226.9818. The IMFP of PLL-g-PEG at the energy of Ti 2p photoelectrons, λ^{PLL-g-PEG/Ti2p} (nm), at a binding energy of ˜0.454 keV (kinetic energy of ˜0.933 keV using Al Kα radiation) can be calculated using equation (2) derived by Cumpson (Cumpson et al, Surface and Interface Analysis, 2001, 31, 23-34):

$${λ}_{i} = [ \frac{3.117 ( {}_{}^{0}{χ}{}_{}^{( v )} ) + 0.4207 {N}_{rings}}{{N}_{non \text{-} H}} + 1.104 ] {( E )}^{0.79} \qquad ( 2 )$$

Where N_{rings} is the number of aromatic six-member rings in the polymer repeat unit, N_{non-H} is the number of atoms in the polymer repeat unit and E is kinetic energy in keV. The calculated λ^{PLL-g-PEG/Ti2p} is found to be 2.85 nm.

Overlayer thickness can be determined from the attenuation in the substrate signal Ti 2p using equation (3) (Briggs et al, Surface Analysis by Auger and X-ray Photoelectron Spectroscopy, IM Publications LLP, Chichester, 2003; and Sofia et al, Macromolecules 1998, 31, 5059-5070):

$$z = - λ \times cos θ \times ln ( \frac{I}{{I}_{∞}} ) \qquad ( 3 )$$

Where z is the effective dry thickness of the adsorbed PLL-g-PEG (nm), λ is the IMFP of Ti 2p photoelectron through PLL-g-PEG (2.85 nm), θ is the photoemission angle)(0°, I is the relative atomic percentage of Ti 2p from PLL-g-PEG on TiO₂ and I_{∞} is the relative atomic percentage of Ti 2p from the bare TiO₂ surface.

The average distance between the PEG chains, L (nm), was calculated using the effective dry thickness, z, derived from the XPS using equation (4) (Sofia et al, Macromolecules 1998, 31, 5059-5070):

$$L = {( \frac{M}{p z n PEG {N}_{A}} )}^{\frac{1}{2}} \qquad ( 4 )$$

Where M is the molecular weight of the PLL-g-PEG, ρ is the density of PLL-g-PEG (≈1 g/cm³), n_{PEG} is the total number of PEG chains in one PLL-g-PEG molecule (˜43 units) and N_{A} is the Avogadro's number. According to Perry et al (Perry et al, ACS Applied Materials & Interfaces 2009, 1, 1224-1230), provided that the PEG chains possesses hexagonal close packed arrangement, the relationship between the L and the surface packing density, σ (nm⁻²), can be expressed as equation (5):

$$L = {( \frac{4}{3} )}^{\frac{1}{4}} {σ}^{- \frac{1}{2}} \approx {σ}^{- \frac{1}{2}} \qquad ( 5 )$$

To determine L/2R_{g}, the radius of gyration, R_{g} (nm) of the PEG side chains was determined from equation (6) (Kenausis et al, The Journal of Physical Chemistry B 2000, 104, 3298-3309):

R_{g}=0.181 N^{2Rg} (6)

Where N is the number of EG repeat units (˜113 units) and R_{g} was determined to be 2.80 nm.

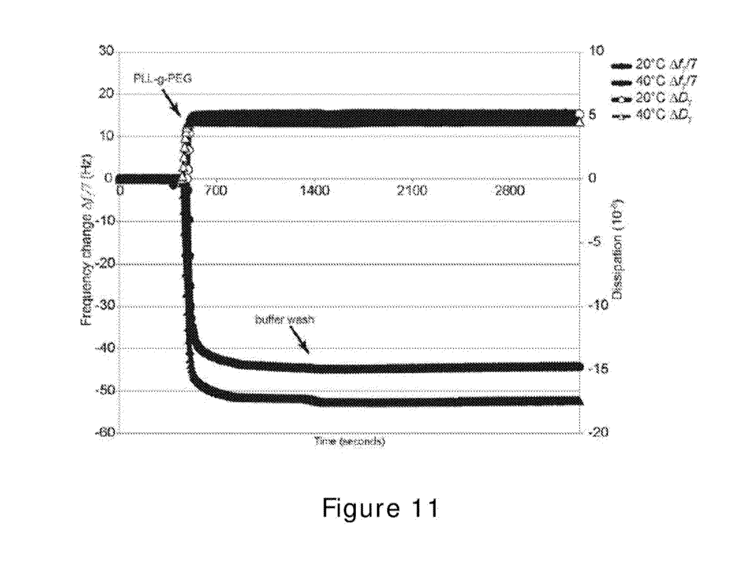

The L/2R_{g} value provides information on the overlapping of PEG chains (Kenausis et al, The Journal of Physical Chemistry B 2000, 104, 3298-3309) and the value of 0.478 for the 20° C. PLL-g-PEG is comparable to the previously published results for the studied PLL-g-PEG (Perry et al, ACS Applied Materials & Interfaces 2009, 1, 1224-1230). Interestingly the value decreased with increase in preparation temperature, with the L/2R_{g} value of 0.256 was achieved for the 80° C., indicating an extremely dense PEG layer with stretched brush conformation (Perry et al, ACS Applied Materials & Interfaces 2009, 1, 1224-1230). To our knowledge, the L/2R_{g} value of 0.256 has never been observed for a PLL-g-PEG system (Kenausis et al, The Journal of Physical Chemistry B 2000, 104, 3298-3309). Quartz crystal microbalance with dissipation (QCM-D) confirmed that the frequency shift, Δf, and dissipation, ΔD, observed for PLL-g-PEG at 20° C. is comparable to the previously published data. An increase in the Δfₙ/n and decrease in Dₙ/(Δfₙ/n) was observed at n=3^{rd}, 5^{th} and 7^{th} overtones for 40° C., an indication of a more rigid PLL-g-PEG layer with higher surface mass density compared to 20° C. (FIG. 11, Table 1).

TABLE 1
Summary of changes in frequency and dissipation
(mean ± SD) at nth tone (Δfₙ/n^{th} and ΔDₙ) for n = 3, 5, 7 upon
adsorption of PLL-g-PEG at 20° C. and 40° C.
Δfₙ/n^{th} and ΔDₙ

| | n = 3 | | | n = 5 | | | n = 7 | | |
|---|---|---|---|---|---|---|---|---|---|
| Adsorption | Δf₃/3 | ΔD₃ | | Δf₅/5 | ΔD₅ | | Δf₇/7 | ΔD₇ | |
| temperature | (Hz) | (10⁻⁶) | ΔD₃/Δf₃/3 | (Hz) | (10⁻⁶) | ΔD₅/Δf₅/5 | (Hz) | (10⁻⁶) | ΔD₇/Δf₇/7 |
| 20° C. | 51.74 | 4.54 | 0.09 | 47.37 | 5.12 | 0.11 | 44.13 | 5.06 | 0.11 |
| | (0.47) | (0.16) | (0.003) | (0.48) | (0.24) | (0.005) | (0.48) | (0.14) | (0.003) |
| 40° C. | 58.04 | 2.47 | 0.04 | 55.63 | 4.04 | 0.07 | 52.22 | 4.29 | 0.08 |
| | (8.04) | (1.29) | (0.016) | (3.67) | (0.25) | (0.006) | (0.67) | (0.51) | (0.01) |

Taking visco-elastic properties of the layer into account, Voigt modeling has further confirmed the increase in surface mass density for adsorption at 40° C. compared to 20° C. (Table. 2).

TABLE 2
Surface mass density,, (mean ± SD) calculated by using the
Voigt model, including n = 3, 5, 7, 9, 11^{th} overtones.
Voigt model

| Adsorption temperature | Surface mass density |
|---|---|
| 20° C. | 318 ± 5 ng/cm² |
| 40° C. | 359 ± 23 ng/cm² |

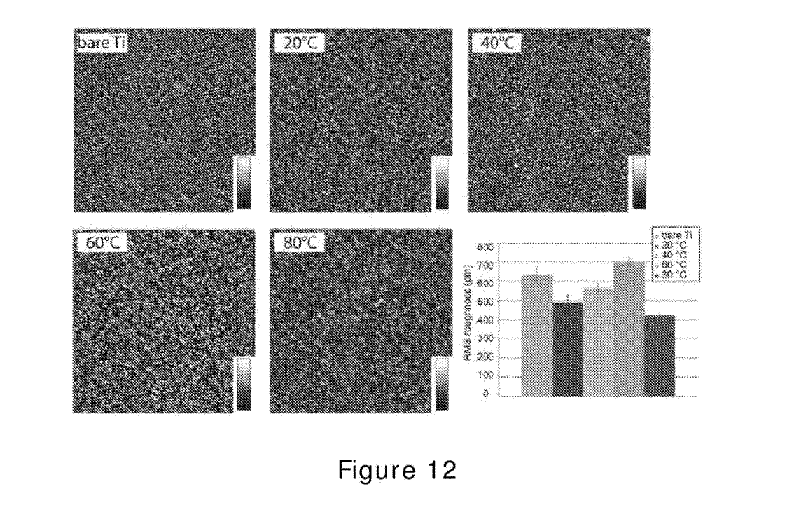

Topographical data from atomic force microscopy (AFM) revealed picometer range RMS roughness observed for all the surfaces without aggregates (FIG. 12).

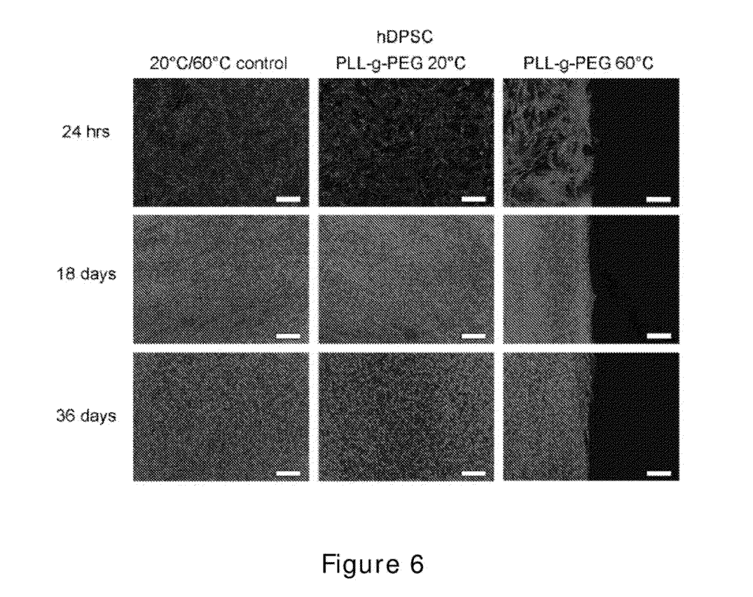

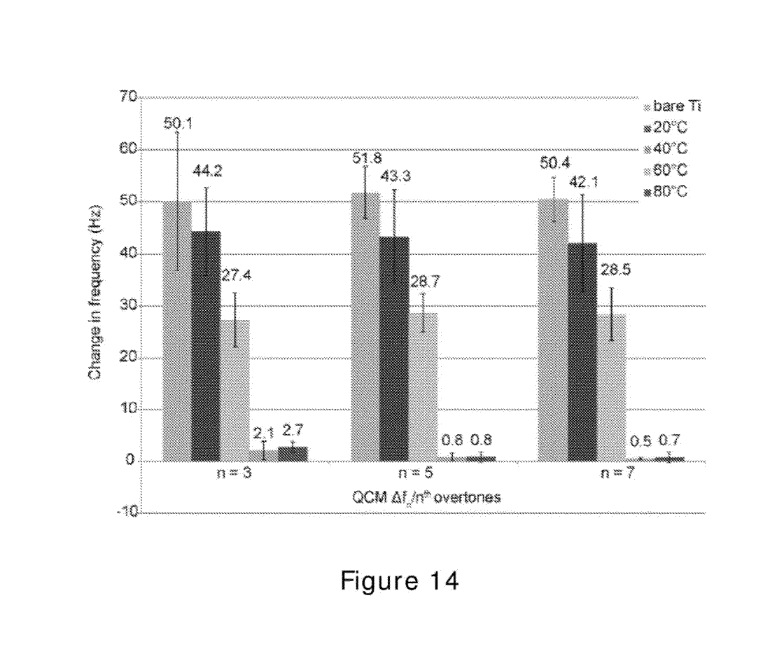

To test the bio-resisting capability, the inventors exposed the PLL-g-PEG surfaces prepared at 20° C. and 60° C. to two different types of mammalian cells (human dental pulp stem cells (hDPSC) and human fibroblast cells (hFb) up to 36 days under standard cell-culturing conditions (FIG. 6+7). Each substrate was half masked with a clean room tape, thus the PLL-g-PEG was assembled only on the exposed half. This approach allows stringent testing of the surfaces towards initial cell adhesion and cell migration. The inventors note here that only the surfaces prepared from 20 and 60° C. were tested, as the clean room tape becomes detached if incubated at 80° C. The control substrates were also included where the masked substrates were only incubated in 10 mM HEPES buffer at 20 and 60° C. At all-time points, the control surfaces show extensive adhesion and proliferation for both cell types over the entire substrate. This was also the case for the PLL-g-PEG surfaces prepared at 20° C. at the 24 hour time point where the intersection between the PLL-g-PEG coated and uncoated regions could not be distinguished. This failure may be due to the limited hydration time given to the PEG (approx. 5 mins in PBS during washing steps) prior to the cell seeding. Despite this limited hydration time, the inventors observed a clear intersection between the coated and uncoated regions for the 60° C. surfaces after 36 days of incubation, with zero adhesion and migration for both cell types. At 60° C., the inventors conducted further tests achieving zero adhesion over 36 days with an additional cell type (MC3T3 cells, FIG. 14a) and a substrate with surface negative charge at physiological pH (tissue culture polystyrene (TCPS) using hDPSC, FIG. 14b).

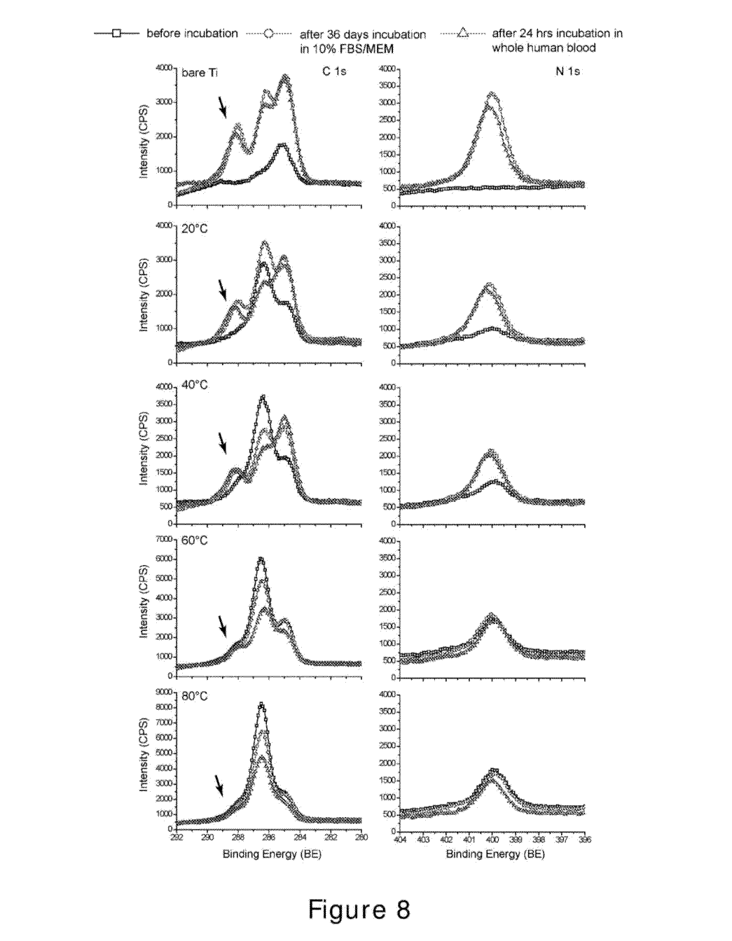

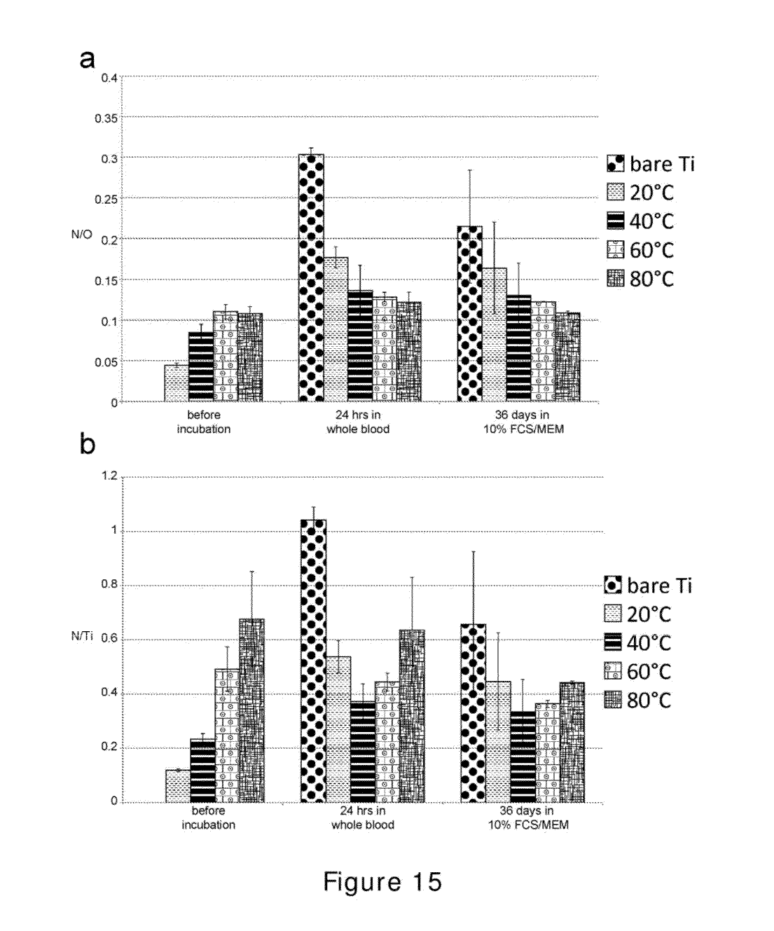

QCM-D was used to monitor the Δfₙ/n^{th} (n=3, 5, 7) change upon exposure to 10% FBS/MEM over a short time period (30 minutes at 37° C., FIG. 14). Compared to the bare TiO₂ surface, a gradual reduction of Δfₙ/n^{th} was observed with increase in the preparation temperature from 20 to 40° C., with Δfₙ/n^{th} change of near zero was achieved for the 60 and 80° C. To determine the level of protein adsorption, the inventors also incubated the surfaces in 10% FBS/MEM continuously for 36 days at 37° C., subsequently washed in MQ water and analyzed using XPS (FIG. 8). By monitoring the intensity change of N—C(═O) components from the C 1s spectra (indicated by black arrows) and the peak intensity change of N 1s before (FIG. 8) and after incubation, a significant increase in the intensities were observed for the bare TiO₂, 20 and 40° C. surfaces after the incubation, indicative of the adsorbed proteins from the media. Slight decreases in intensities were observed for the 60 and 80° C. surfaces. The inventors additionally tested the surfaces in undiluted whole blood at 37° C. for 24 hours (FIG. 8) and the same trend was observed. The N/O elemental ratio, before and after incubation (FIG. 15a), indicates that significant protein adsorption has occurred for the 20 and 40° C. samples. Interestingly, for the 60 and 80° C., negligible changes in the N/O and more clearly, the C 1s and N 1s high resolution scans before and after incubation revealed that there are no protein adsorptions observed within the detection limit of XPS. Concurrent decreases in the N/Ti elemental ratio for samples incubated for 36 days with 10% FBS/MEM (FIG. 15b) and the C—O signal before and after the incubations from the high resolution C 1s spectra (FIG. 8) suggests that some of the PLL-g-PEG have desorbed from the surface. Provided that there are no protein adsorption, the L/2R_{g} values after the incubations is 0.276 for 24 hours in blood and 0.312 for 36 days in 10% FBS/MEM for the 80° C. surface, highlighting that the desorption was more extensive over a longer incubation period, but nevertheless maintained high PEG surface density relative to 20 and 40° C. surfaces.

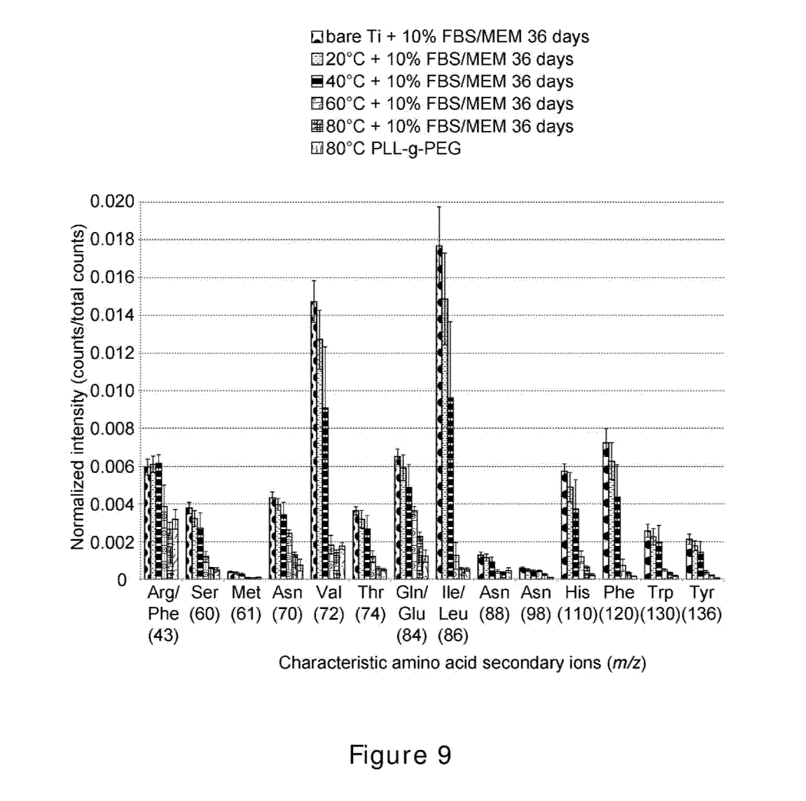

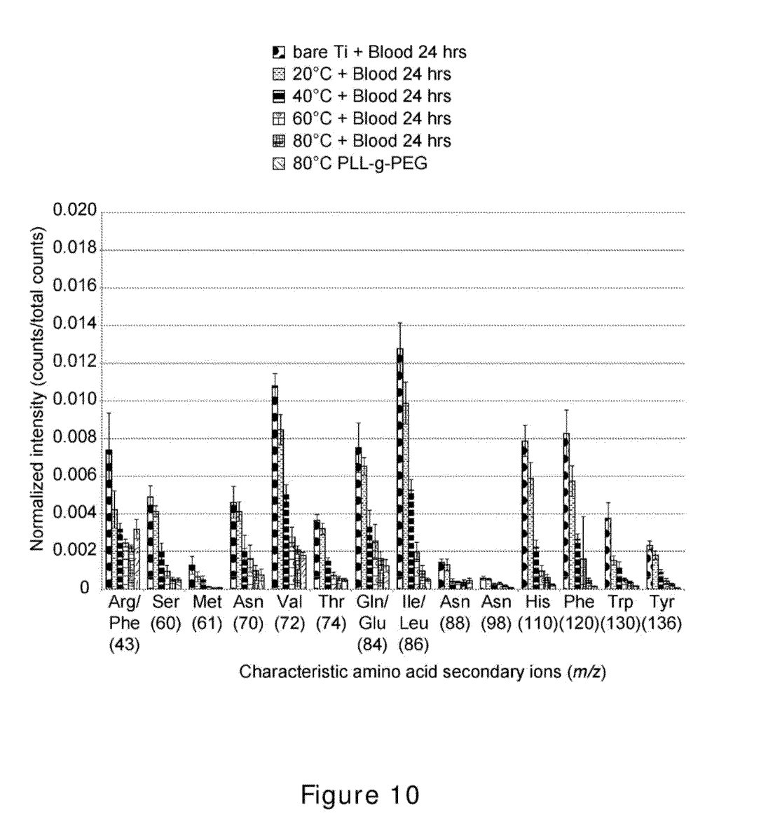

To determine the level of fouling further, the inventors employed ToF-SIMS and monitored the secondary ion intensities of 14 amino acid fragments that are solely derived from proteins and not from PLL-g-PEG nor substrate (10% FBS/MEM: FIG. 9 and whole blood: FIG. 10. Spectral overlay of individual amino acid peaks are performed, but not shown). Negligible differences in the normalized secondary ion intensities of all 14 amino acid fragments were observed between the exposed and non-exposed 80° C. surfaces after 24 hours of incubation in blood and 36 days in 10% FBS/MEM within the atto-molar detection limit or down to as low as 0.1 ng/cm² (Wagner et al, Journal of Biomaterials Science, Polymer Edition 2002, 13, 407-428) of ToF-SIMS, highlighting the level of superior resistance of temperature induced PLL-g-PEG surfaces over currently available non-fouling surfaces.

This study has conclusively shown that the grafting temperature has a dramatic effect on the grafted density of electrostatically driven adsorption of PLL-g-PEG, which in turn is extremely critical for resisting bio-adhesion. Based on the previous studies on zeta potential and temperature (Revil et al, J. Geophys. Res. 1999, 104, 20021-20031), and since PLL-g-PEG does not reach the CP in the low ionic strength condition that was used in this study, the inventors postulate that increasing the temperature results in; (1) producing more negative surface sites on the substrate surface; (2) significant increase in electrostatic attraction occurs between the polyelectrolyte and the surface; (3) forming densely packed PLL-g-PEG on the substrate surface by overcoming the steric repulsion experienced between the PEG chains leading to stretched-brush formation as indicated by increase in the L/2R_{g} determined from the XPS. It is also possible that a multilayer of PLL-g-PEG has formed in elevated temperature conditions, but since our protocol involves in copiously washing the assembled surface at room temperature, the inventors suspect that most of the physically adsorbed PLL-g-PEG should be washed away. Alternatively, it is possible that the physically adsorbed PLL-g-PEG could have acted as a ‘sacrificial layer’ for resisting bio-adsorption. The kinetics and mechanisms of grafting is rather speculative from this study alone but nevertheless our approach has, for the first time, achieved ‘zero’ cell adhesion and protein adsorption in most pertinent conditions with atto-molar detection limit. The methodology is simple, effective and applicable for a wide range of biotechnological and biomedical applications. The presented study should stimulate further research towards other electrostatically driven systems to elucidate the effect of temperature on the kinetics and mechanisms of the grafting in detail.

### Example 2

### Polydopamine (PDA) Adlayer During Temperature-Induced Grafting Enhances the Stability of Temperature Induced PLL-g-PEG Coating

The inventors experimentally demonstrated, that polydopamine (PDA) can be used in addition to increase the stability of PLL-g-PEG coating under high ionic strength condition. PLL-g-PEG adsorbs onto negatively charged substrates via the electrostatic interaction. Thus, in a high ionic strength condition, it is possible that the interaction between the PLL-g-PEG and the substrate may be weakened as the result of charge screening from the counter ions present in the solution; consequently leading to the desorption of PLL-g-PEG. It is known that, due to the presence of catechol/quinone groups on the surface of PDA, amine and thiol groups can be readily covalently coupled to the PDA surface via Schiff base/Michael reaction (Lee et al, Science, 2007, 318, 426-430). The inventors hypothesize that by employing PDA as an intermediate layer, a high density covalently grafted PLL-g-PEG surface can be obtained by (1) initial electrostatic attraction between the underlying TiO₂ substrate and amine groups of PLL-g-PEG in high temperature, possibly as a result of the substrate charge ‘shining through’ thin PDA layer that is below the Debye length of electrostatic forces from ionizable groups of the substrate and PLL-g-PEG and (2) subsequent covalent coupling of PLL-g-PEG to PDA. In addition, due to the multifunctional capability of PDA, the presented approach of PDA/PLL-g-PEG grafting can be applied on virtually any surface type (Lee et al, Science, 2007, 318, 426-430).

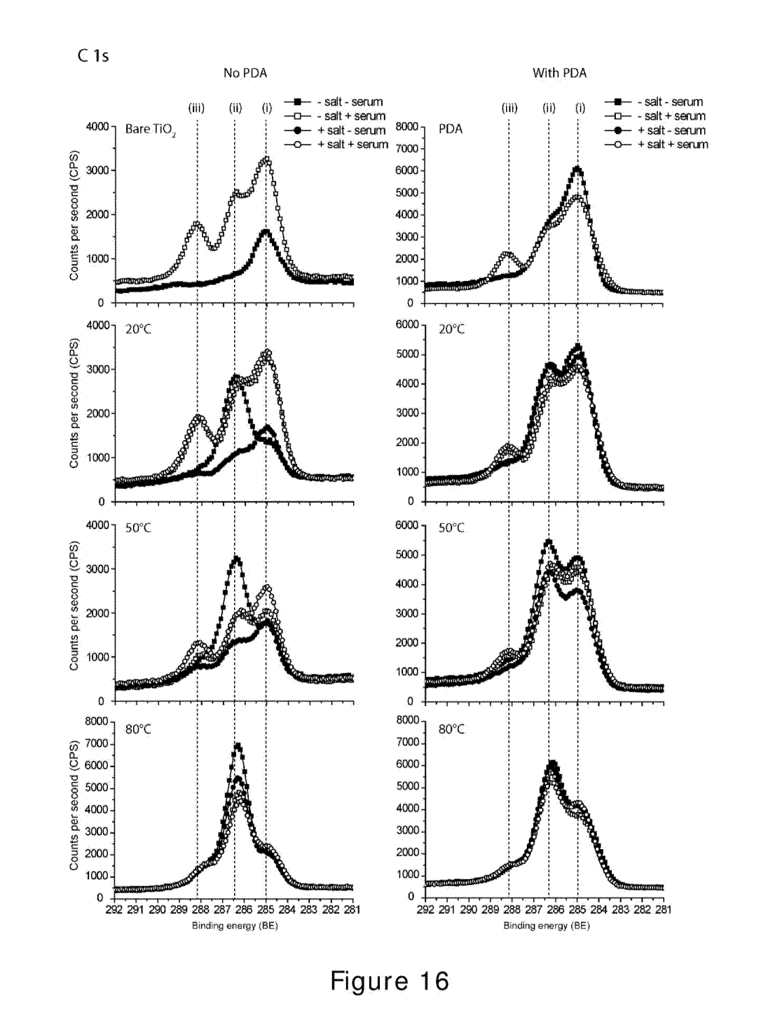

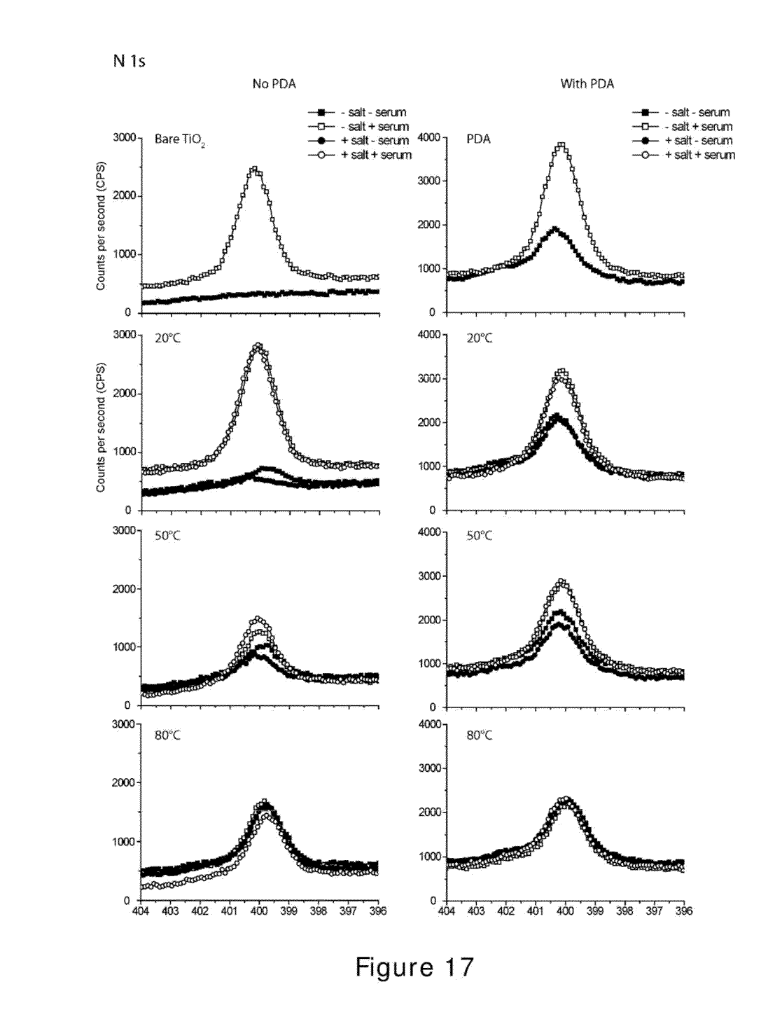

To verify this hypothesis, the inventors have grafted PLL-g-PEG onto TiO₂ surfaces with and without the presence of PDA at different temperatures (20, 50 and 80° C.). These surfaces are then incubated in extremely high ionic strength solution, 2.4M NaCl for 24 hours at 25° C. and washed copiously in MilliQ water. The NaCl treated and untreated surfaces of PLL-g-PEG with and without PDA are then exposed to undiluted FBS for 24 hrs at 37° C. and subsequently washed in MilliQ water and characterized by XPS. The C 1s and N 1s high resolution XPS spectra are shown in FIGS. 16 and 17 respectively. Similar to the XPS results given in Example 1 above, C 1s can be typically separated into three major chemical components; (i) C—C/C—H at BE of 285.0 eV (charge corrected), (ii) C—N/C—O at BE ˜286.5 eV and (iii) N—C(═O)/O—C═O at BE of ˜288.2 eV. Change in the intensities of the components (ii) and (iii) before and after the NaCl and undiluted FBS incubations can provide information on the adsorption/desorption of PEG and proteins from the FBS respectively. Without NaCl incubation and with exposure to FBS, as expected, the rise in the intensity of component (iii) is seen for bare TiO₂ without PDA and as the temperature is increased from 20 to 80° C., the intensity of component (iii) has decreased, with no apparent change in the intensity observed at 80° C. before and after the incubation in FBS. Desorption of PLL-g-PEG are observed for all PLL-g-PEG surfaces upon NaCl incubation, with complete desorption of PLL-g-PEG from the surfaces prepared at 20 and 50° C., leading to reduction in the resistibility of protein adsorption for 50° C. with NaCl treatment. Interestingly for 80° C., although some desorption of PLL-g-PEG are observed upon exposure to NaCl, significant level of PLL-g-PEG remained on the surface and able to completely resist protein adsorption from FBS within the detection limit of XPS. This is supported by the lack of increase in the intensity of N 1s before and after the FBS incubation which was observed for bare TiO₂, 20 and 50° C.

The successful coating of PDA onto bare TiO₂ was confirmed from spectral change in C 1s with increase in component (ii) and (iii). Upon exposure to FBS, higher intensity of component (iii) were observed on PDA surface compared to bare TiO₂, indicating that more proteins have attached onto PDA than bare TiO₂. This was expected, as the free amine groups of the proteins from FBS can covalently couple to the PDA surface, as described above. Increase in the component (ii) confirmed the attachment of PLL-g-PEG onto PDA surface at all temperatures with the highest intensity of component (ii) was achieved at 80° C. A slight reduction in the intensity of all three components were observed for 20 and 50° C. PDA-PLL-g-PEG samples indicating that the PLL-g-PEG that are not covalently coupled to PDA have desorbed from the surface. Despite this small level of desorption, the improved stability of the PLL-g-PEG surface with the use of PDA as an adlayer is evident from the reduced protein adsorption at 20 and 50° C. The PLL-g-PEG surface prepared from 80° C. with the presence of PDA has also shown a complete protein resistance from the FBS. The improved stability of the PLL-g-PEG with PDA is evident from negligible change in the C 1s and N 1s spectra observed before and after the NaCl incubation.

In summary, the presented XPS data indicates that PDA enhances the stability of PLL-g-PEG coating via the covalent coupling in high ionic strength environment thus provides improved protein resistance compared to the surface without PDA. Interestingly, the PLL-g-PEG prepared at 80° C. without PDA has still shown a complete resistance of proteins from FBS, indicating that the density of PLL-g-PEG after the NaCl incubation was still sufficient. The degree of PLL-g-PEG desorption seems less from the PLL-g-PEG prepared at 80° C. compared to 20 and 50° C. The inventors propose that this effect may be due to the rearrangement and densely grafted PLL-g-PEG may hinder the access of counter ions that leads to the screening of surface charge.

### Example 3

### Effect of Temperature Increase During Grafting in Relation to Bacterial Fouling

Cell assays using bacterial cells were conducted to test the anti-fouling capability of metal surfaces coated using the increased temperature method of the present invention.

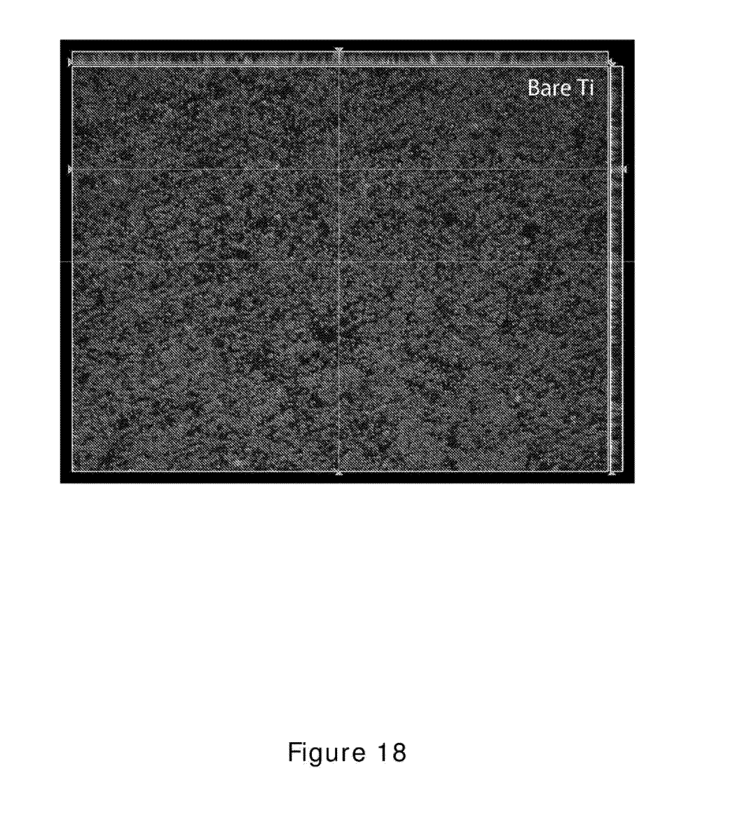

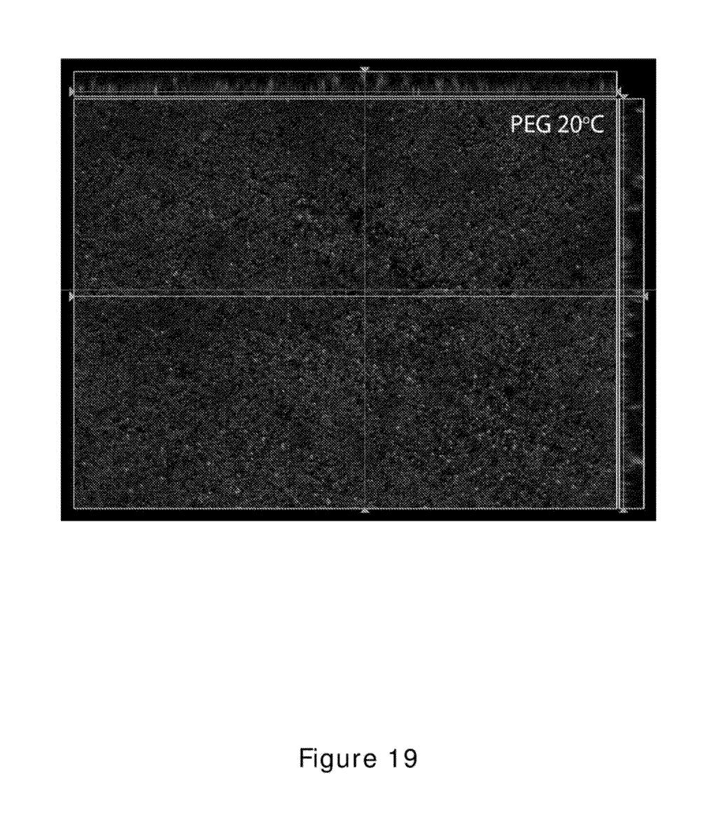

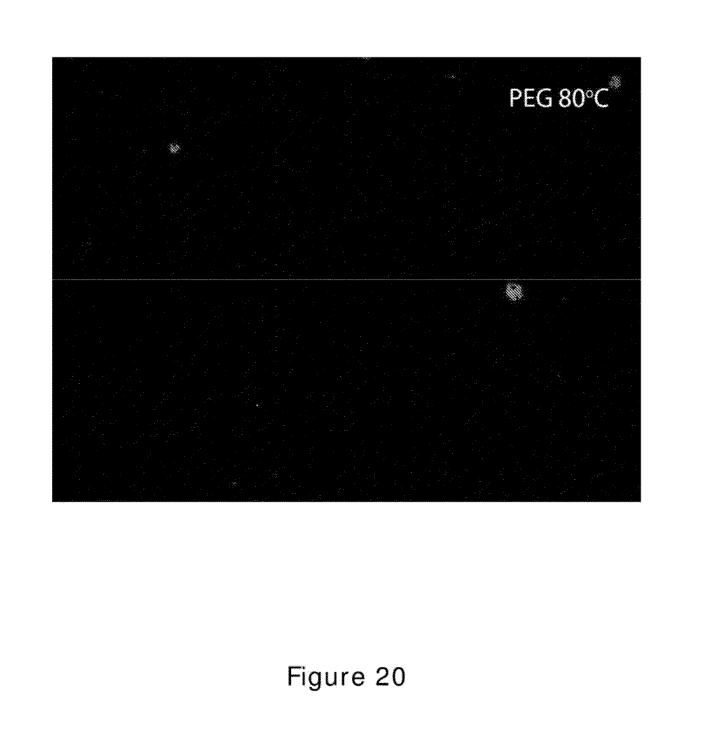

Thus, FIGS. 18-20 depicts LiveDead stain (a mixture of fluorescent dyes, Sybergreen and propedium iodide (Red)) images of bare titanium (FIG. 18), PLL-g-PEG surface prepared at 20° C. (FIG. 19) and PLL-g-PEG surface prepared at 80° C. (FIG. 20) after incubation in 3% Tryptic Soy Broth with Staphylococcus aureus without shaking at 37° C. The improved anti-fouling capability of the PLL-g-PEG surface obtained when using 80° C. as compared to 20° C. and bare Titanium is clearly demonstrated.

### Example 4

### Long Term Bioresistance of Biotin Functionalized PLL-g-PEG in Whole Blood Via Temperature Increase During Grafting

In relation to biomedical applications it is important to achieve improved long term anti-fouling capabilities of surfaces in for example medical devices. Also, the ability to functionalize the anti-fouling surfaces with biologically relevant molecules while maintaining the zero-fouling capabilities is advantageous.

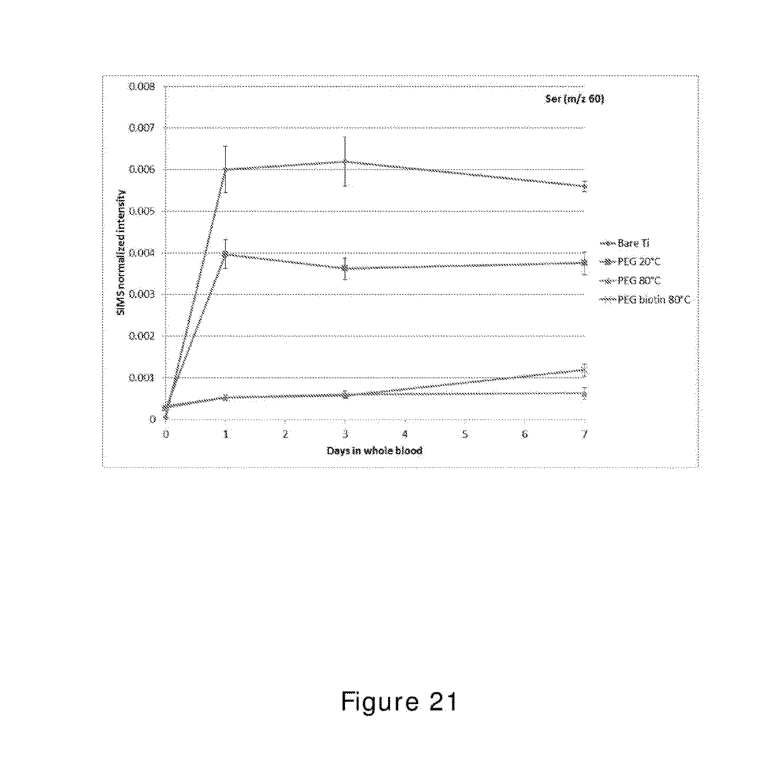

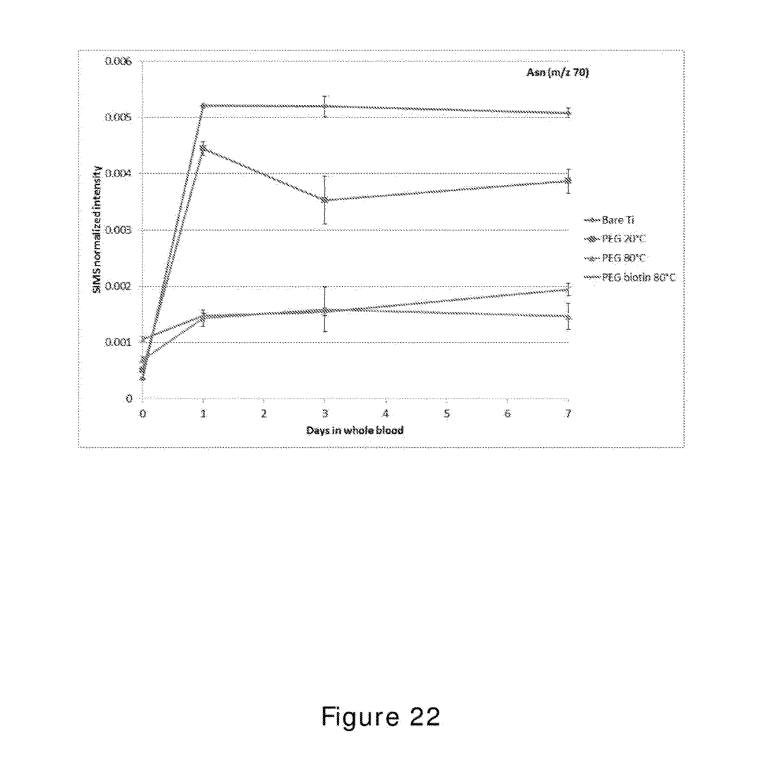

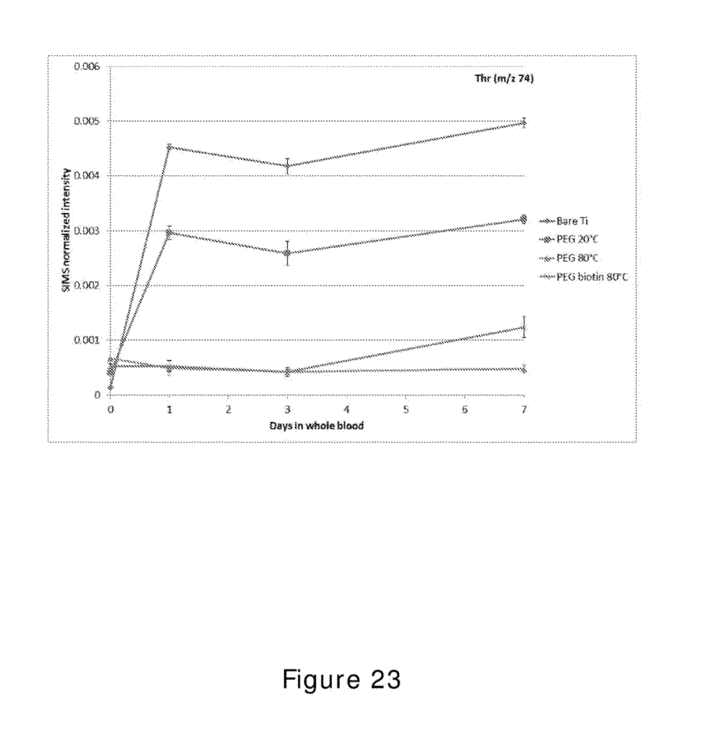

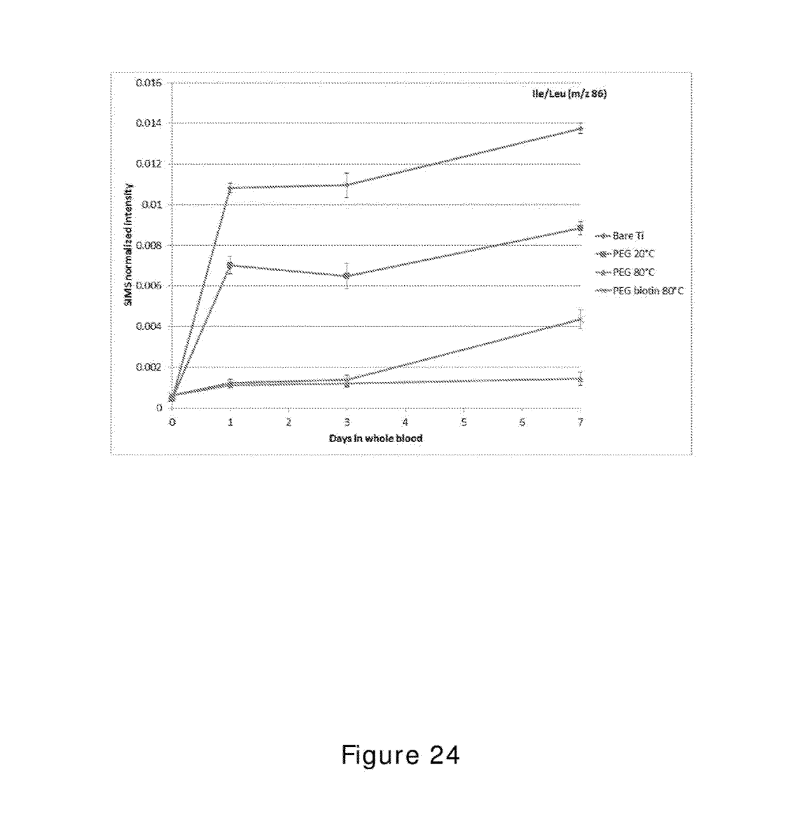

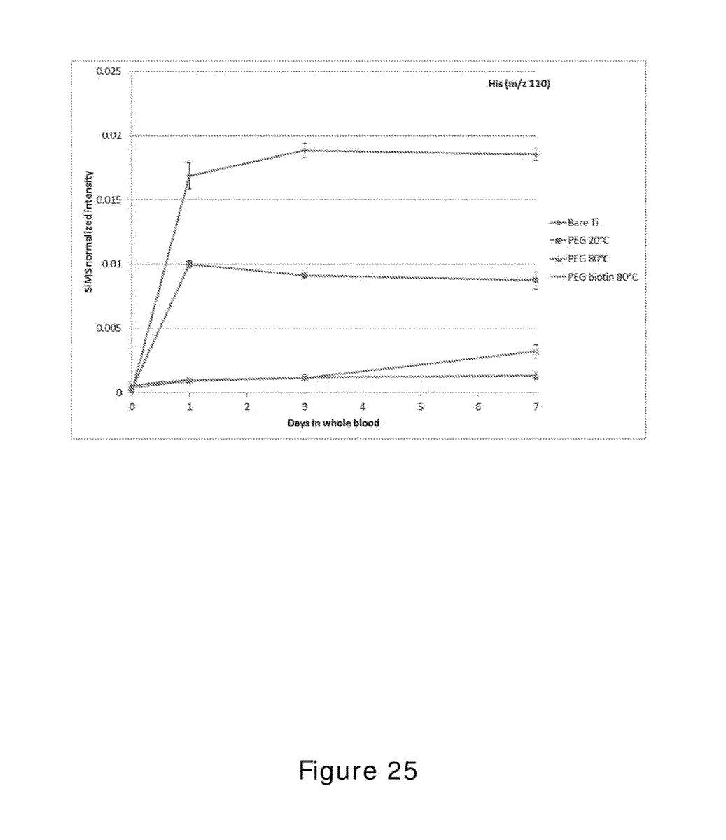

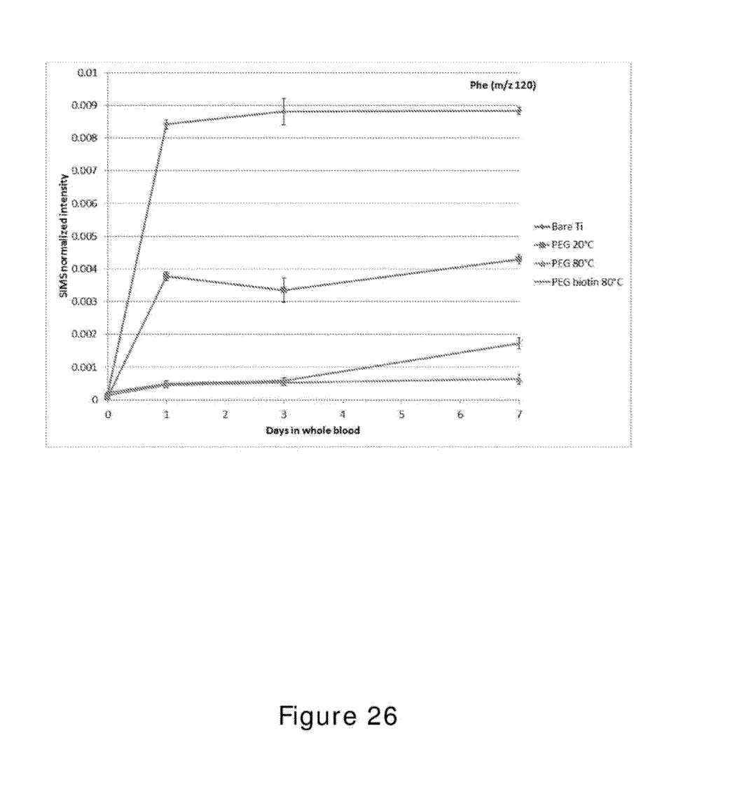

Thus, a study was made to determine the antifouling capability of the surfaces of the present invention compared to bare titanium and low temperature (20° C.) PLL-g-PEG surfaces over 7 days in whole blood, including surfaces where the PLL-g-PEG is functionalized with biotin. Normalized secondary ion intensities of 12 amino acids from ToF-SIMS analysis are plotted against number of days in whole blood. The results are shown for selected amino acids in FIGS. 21-26.

The superior bioresistance in whole blood of PLL-g-PEG and PLL-g-PEG biotin prepared at 80° C. is evident when compared to those surfaces that been treated at 20° C.

### Example 5

### Increase in the Maximum Adsorption Ability when Using Increased Temperatures

Being able to control the adsorption level of anti-fouling surfaces simply by adjusting the incubation time of the substrate with the surface co-polymer would be highly advantageous.

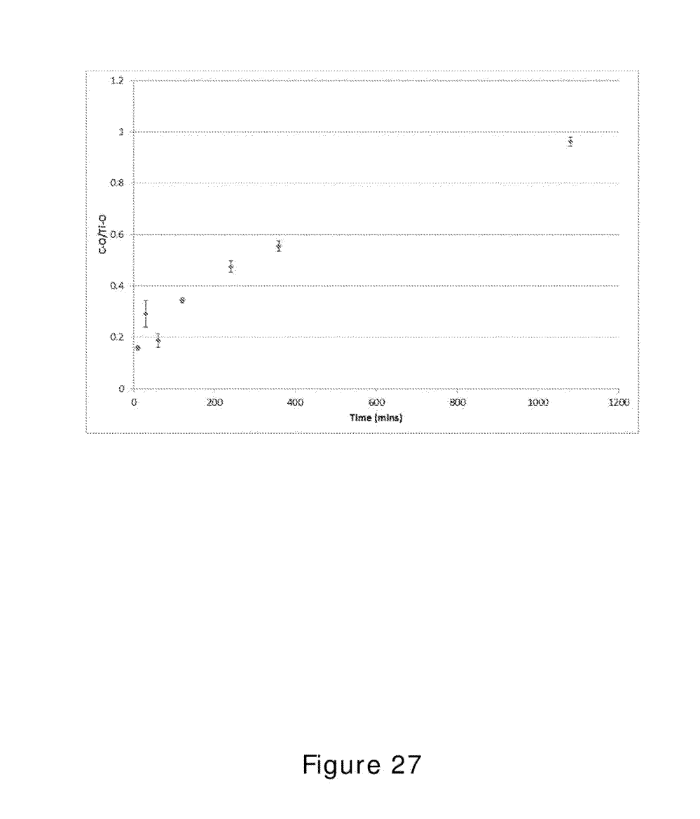

Contrary to the adsorption behavior of PLL-g-PEG at 20° C., where maximum adsorption is achieved typically 10 to 30 mins (e.g. Kenausis et al J Phys. Chem. B 2000), the inventors have demonstrated in a study with XPS that the amount of PLL-g-PEG adsorption on a titanium surface increases with incubation time when incubated at 80° C. This is highlighted by increasing ratio of ether (C—O, indicative of PEG) to Ti (Ti—O, indicative of substrate) with incubation time. The results are shown in FIG. 27, where the adsorption is still increasing in a near-linear fashion even after 1000 minutes.

### Materials and Substrates:

PLL-g-PEG with PLL (M_{w} 24,000 Da) and PEG (M_{w} 4,850), with a PLL to PEG ratio (g) of 3.3 were purchased from SuSoS AG (Dubendorf, Switzerland). PLL-g-PEG-biotin (PLL(20 kDa)-g[3.5]-PEG(2 kDa)/PEG(3.4 kDa)-biotin(50%)) was purchased from SuSoS AG (Dubendorf, Switzerland). In this PLL-g-PEG 45-65% of the PEGs are functionalized with biotin. Dopamine hydrochloride was purchased from Sigma Aldrich (Copenhagen, Denmark). Ti surfaces (100 nm) were prepared from PVD sputtering of Ti on silicon (110) wafer from Silicon Materials (Kaufering, Germany), in a standard chamber equipped with a RF sputtering system at an Ar pressure of 2×10⁻³ mbar from 10 cm diameter Ti target at 200 W (2.54 W cm⁻²). The distance between the substrate and target was 7 cm, giving a deposition rate of 0.4 nm s⁻¹.

### PLL-g-PEG Adsorption:

Sputter coated TiO₂ substrates were cleaned by UV/ozone treatment for 20 minutes, followed by ultrasonication in ethanol and MQ water for 20 mins each. The substrates were dried in N₂ and immediately immersed in PLL-g-PEG in 10 mM HEPES buffer with the concentration of 100 μg/ml and incubated for at least 20 hrs in a given temperature (20, 40, 60 and 80° C.). The surfaces were copiously rinsed in MQ water and dried in N₂.

### PDA Coating:

TiO₂ surfaces were immersed in solution of dopamine hydrochloride (1 mg/ml) dissolved in 10 mM TRIS buffer (adjusted to pH 8.5) and incubated for 60 mins. The surfaces are then copiously washed with MilliQ water and dried in N₂.

### QCM-D:

QCM-D data acquisitions were performed using Q-Sense E4 system (Gothenberg, Sweden). All data acquisitions were performed in at least triplicates. Real-time PLL-g-PEG (100 μg/ml) adsorption experiments were performed in temperature stabilized HEPES buffer at 20° C. (20.0±0.01° C. s.d.) and 40° C. (39.8±0.01° C. s.d.). Due to the instrument's maximum operating temperature, the adsorption temperature of 20 and 40° C. were only studied. For cell media adsorption experiment, PLL-g-PEG surfaces were prepared at various temperatures and first stabilized in PBS buffer (10 mM) and 750 μl of MEM with 10% FBS were introduced at 37° C.

Bioadsorption Testing from Cell Media and Whole Blood for XPS and ToF-SIMS:

The PLL-g-PEG surfaces prepared in various temperatures are incubated separately in; (1) 10% FBS/MEM for 36 days and (2) in human whole blood (surfaces were immediately incubated after drawing venous blood from apparently healthy donor) for 24 hrs. Both incubations were conducted at 37° C. After incubation all surfaces are washed copiously in PBS buffer and MQ water and analysed using XPS and ToF-SIMS.

### XPS:

XPS data acquisitions were performed using a Kratos Axis Ultra^{DLD} instrument (Kratos Analytical Ltd., Telford, UK) equipped with a monochromated Al ka X-ray source (hv=1486.6 eV) operating at 10 kV and 15 mA (150 W). Survey spectra (binding energy (BE) range of 0-1100 eV with a pass energy of 160 eV) and high resolution spectra (with pass energy of 20 eV) of C 1s, O 1s and N 1s were obtained to determine chemical state information. All data acquisition were performed over two areas per sample and repeated at least once. The acquired data were converted to VAMAS format and analysed using CASAXPS software (CASA XPS Ltd, UK). The BE scales for the high resolution spectra were calibrated by setting the BE of the C 1s C—C/C—H component to 285.0 eV. Peak fittings were conducted using Shirley background and with Gaussian/Lorenzian functions of 30%/70%. Chemical species were identified by referring to the XPS database.

### ToF-SIMS:

ToF-SIMS data acquisition spectra were acquired using a ToF-SIMS V Time-of-Flight Secondary Ion Mass Spectrometer (IONTOF GmbH, Muenster, Germany) in high mass resolution mode (high current bunched′ mode). The data was acquired using 15 keV Bi₁⁺ ions rastered in a 128×128 (x,y) line format over a 150 μm×150 μm area. Ion current was measured in the Faraday cup mounted on the sample holder and the Bi₁⁺ current was below 1 pA with a cycle time of 120 μs which provides m/z range of 0 to 1064. Mass resolution (m/Lm) was measured on the surface of the clean silicon wafer and the m/Lm in the positive mode at m/z 29 was found to be above 9,000 with H pulse width of 0.58 ns. All data acquisition were performed over six areas per sample, repeated at least once and acquired in the ‘static mode’ of not exceeding 10¹³ primary ions/cm². All the acquired SIMS data were analysed using Surface Lab 6 software (IONTOF GmbH, Germany). Mass calibration of the positive spectra was performed by selecting CH₃⁺ (m/z 15.0235), C₂H₅⁺ (m/z 29.0394), C₃H₇⁺ (m/z 43.0544) and C₇H₇⁺ (m/z 91.0558).

### AFM:

All AFM images were acquired using JPK Nanowizard 2 (Berlin, Germany) in tapping mode using silicon nitride cantilever (Olympus AC series with typical spring constant of 26 Nm⁻¹ and tip radius of 7 nm). All images were acquired in air over three areas per surface and analyzed using JPK Image Processing software.

### Cell Assays:

All cell assays were performed in triplicates of each surface type. Clean TiO₂ substrates were half-masked using clean room tape and the surfaces were immersed in PLL-g-PEG (100 μg/ml) for at least 20 hrs. Clean room tape was peeled off and rinsed in PBS, 70% ethanol and PBS prior to cell seeding. All cell types were seeded at 40,000 cells/cm² for 24 hour samples and 9,000 cells/cm² for 18 and 36 days samples using ‘standard’ cell culture conditions (Gibco minimum essential media (MEM) supplemented with 10% fetal bovine serum (FBS) and 1% penicillin-streptomycin antibiotic solution incubated at 37° C. and 5% CO₂). Culture media were changed twice a week for 18 and 36 days samples. After the cell culture, surfaces were rinsed in PBS and cells were fixed using 4% formaldehyde. Staining of cell nucleus and actin cytoskeleton were performed using 4,6-diamidino-2-phenylindole (DAPI) and Phalloidin. Light microscope (Leica DM6000B) and Leica Qwin software was used to capture five images of each surface at ×10 magnification.

The bacterial cell assays where performed on bare titanium, PEG20 (PEG surfaces prepared under 20° C.) and PEG80 (PEG surfaces prepared under 80° C.) and the surfaces were incubated in 3% Tryptic Soy Broth with Staphylococcus aureus. The setup was incubated for 24 hours without shaking at 37° C. After incubation, individual surfaces were rinsed with PBS by submerging the surfaces in the buffer 3 times. Finally, LiveDead stain (a mixture of fluorescent dyes, Sybergreen and propedium iodide (Red)) was applied on the surfaces and covered with glass coverslip. Samples were visualized under fluorescent microscope. Green cells indicate living and red cells indicate dead bacteria in the biofilm.

### REFERENCES

P. Kingshott, H. Thissen, H. J. Griesser, Biornaterials 2002, 23, 2043-2056.
T. M. Blattler, S. Pasche, M. Textor, H. J. Griesser, Langmuir 2006, 22, 5760-5769.
P. J. Cumpson, Surface and Interface Analysis, 2001, 31, 23-34.
D. Briggs, J. T. Grant, Surface Analysis by Auger and X-ray Photoelectron Spectroscopy, IM Publications LLP, Chichester, 2003
S. J. Sofia, V. Premnath, E. W. Merrill, Macromolecules 1998, 31, 5059-5070.
S. S. Perry, X. Yan, F. T. Limpoco, S. Lee, M. Müller, N. D. Spencer, ACS Applied Materials & Interfaces 2009, 1, 1224-1230.
G. L. Kenausis, J. Vörös, D. L. Elbert, N. Huang, R. Hofer, L. Ruiz-Taylor, M. Textor, J. A. Hubbell, N. D. Spencer, The Journal of Physical Chemistry B 2000, 104, 3298-3309.
M. S. Wagner, S. L. McArthur, M. Shen, T. A. Horbett, D.
G. Castner, Journal of Biornaterials Science, Polymer Edition 2002, 13, 407-428.
P. A. Revil, P. W. J. Pezard, J. Glover, Geophys. Res. 1999, 104, 20021-20031.
H. Lee, S. M. Dellatore, W. M. Miller, P. B. Messersmith, Science, 2007, 318, 426-430.

1. A method for modifying a surface characteristic of a product comprising:
a) Providing a product comprising a bulk part and a surface region, said surface region being positively or negatively charged;
b) Contacting at least a portion of the surface region with an aqueous coating composition having a temperature of at least 60 degrees Celsius to form a first surface region coating on at least a first part of said surface region;
wherein the aqueous coating composition comprises a polyionic co-polymer consisting of a polyionic backbone polymer and non-ionic hydrophilic side chain polymers;
wherein the liquid matter of the aqueous coating composition comprises at least 50% w/w of water;
provided that when the surface region is positively charged, said polyionic backbone polymer being negatively charged;
provided that when the surface region is negatively charged, said polyionic backbone polymer being positively charged;
wherein said polyionic co-polymer has a cloud point above the temperature of said coating composition when brought into contact with said at surface region under step b).

2. A method according to claim 1, wherein the aqueous coating composition further comprises a buffer.

3. (canceled)

4. (canceled)

5. A method according to claim 1, wherein the polyionic backbone polymer has a cationic charge at a pH of 7.4.

6. A method according to claim 5, wherein the polyionic backbone polymer comprises a cationic backbone selected from the group consisting of polymers comprising amino acids containing side group imparting a positive charge to the backbone at a pH of 7.4, polysaccharides, polyamines, polymers of quaternary amines, and charged synthetic polymers.

7. (canceled)

8. A method according to claim 1, wherein the polyionic backbone polymer has an anionic charge at a pH of 7.4.

9. A method according to claim 8, wherein the polyionic backbone polymer comprises a polymer selected from the group consisting of polymers comprising amino acids containing pendant charged groups imparting a negative charge to the backbone at a pH of 7.4, polysaccharides, and charged synthetic polymers with pendant negatively charged groups.

10. (canceled)

11. A method according to claim 1, wherein the non-ionic hydrophilic side chain polymers are selected from the group consisting of poly(alkylene glycols), poly(alkylene oxides), neutral water-soluble polysaccharides, polyvinyl alcohol, poly-N-vinyl pyrrolidone, non-cationic poly(meth)acrylates and combinations thereof.

12. A method according to claim 1, wherein the polyionic co-polymer is a PLL-g-PEG.

13. A method according to claim 12, wherein the PLL-g-PEG is PLL(20 kDa)-g (3.3)-PEG(5 kDa).

14. A method according to claim 1, wherein the surface region comprises polydopamine.

15. A product obtainable by the process of claim 1.

16. A product comprising a bulk part and a surface region;
wherein a first surface region coating is coated on at least a first part of said surface region; said first surface region coating comprising a polyionic co-polymer consisting of a polyionic backbone polymer and non-ionic hydrophilic side chain polymers; wherein the molecular spacing parameter, L/2R_{g}, of said first surface region coating is less than 0.26.

17. (canceled)

18. A product according to claim 16, wherein the polyionic backbone polymer has a cationic charge at a pH of 7.4.

19. A product according to claim 18, wherein the polyionic backbone polymer comprises a cationic backbone selected from the group consisting of polymers comprising amino acids containing side group imparting a positive charge to the backbone at pH of 7.4, polysaccharides, polyamines, polymers of quaternary amines, and charged synthetic polymers.

20. (canceled)

21. A product according to claim 16, wherein the polyionic backbone polymer has an anionic charge at a pH of 7.4.

22. A product according to claim 21, wherein the polyionic backbone polymer comprises a polymer selected from the group consisting of polymers comprising amino acids containing pendant charged groups imparting a negative charge to the backbone at a pH of 7.4, polysaccharides, and charged synthetic polymers with pendant negatively charged groups.

23. (canceled)

24. A product according to claim 16, wherein the non-ionic hydrophilic side chain polymers are selected from the group consisting of poly(alkylene glycols), poly(alkylene oxides), neutral water-soluble polysaccharides, polyvinyl alcohol, poly-N-vinyl pyrrolidone, non-cationic poly(meth)acrylates and combinations thereof.

25. A product according to claim 16, wherein the polyionic co-polymer is a PLL-g-PEG.

26. A product according to claim 25, wherein the PLL-g-PEG is PLL(20 kDa)-g (3.3)-PEG(5 kDa).
